(19) United States
(12) Patent Application Publication
(10) Pub. No.: US 2022/0106490 A1
(43) Pub. Date: Apr. 7, 2022

(54) INK, WATER-BASED DISPERSION, AND PRINTED MATTER

(71) Applicants: Chikako HATTA, Kanagawa (JP); Ryo Miyakoshi, Kanagawa (JP); Takuya Yamazaki, Kanagawa (JP)

(72) Inventors: Chikako HATTA, Kanagawa (JP); Ryo Miyakoshi, Kanagawa (JP); Takuya Yamazaki, Kanagawa (JP)

(73) Assignee: Ricoh Company, Ltd., Tokyo (JP)

(21) Appl. No.: 17/464,865

(22) Filed: Sep. 2, 2021

(30) Foreign Application Priority Data
Oct. 7, 2020 (JP) 2020-169646

(51) Int. Cl. C09D 11/037; C08L 75/04

(52) U.S. Cl. CPC C09D 11/037; C08L 75/04

(57) ABSTRACT

Provided is an ink including: pigment-encapsulating resin particles encapsulating a pigment; and resin particles containing a resin different from a resin of the pigment-encapsulating resin particles.

### CROSS-REFERENCE TO RELATED APPLICATIONS

This patent application is based on and claims priority pursuant to 35 U.S.C. § 119(a) to Japanese Patent Application No. 2020-169646, filed on Oct. 7, 2020, in the Japan Patent Office, the entire disclosure of which is hereby incorporated by reference herein.

### BACKGROUND

### Technical Field

The present disclosure relates to an ink, a water-based dispersion, and a printed matter.

### Description of the Related Art

Inkjet recording apparatuses have advantages such as low noise, low running costs, and easy color-printability, and are widely spread in general households as output devices for digital signals.

In recent years, inkjet techniques have been used not only in home uses but also in commercial uses and industrial uses. In commercial uses and industrial uses, low ink-absorbable coated paper (coat paper) for printing and non-ink-absorbable plastic media are used as recording media. Hence, inkjet recording methods are demanded to realize image qualities of a level comparable to existing offset printing on these recording media.

### SUMMARY

According to an embodiment of the present disclosure, an ink contains pigment-encapsulating resin particles encapsulating a pigment, and resin particles containing a resin different from a resin of the pigment-encapsulating resin particles.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic view illustrating a printing apparatus;

FIG. 2A is a diagram illustrating a three-dimensional image constructed for a single pigment-encapsulating resin particle;

FIG. 2B is a diagram illustrating a surface of a coating film formed of an ink containing pigment-encapsulating resin particles, observed with a scanning electron microscope;

FIG. 2C is a diagram illustrating a surface of a coating film formed of an ink containing: a resin-coated pigment in which a pigment is coated with a resin; and a resin emulsion, observed with a scanning electron microscope;

FIG. 3A is a diagram illustrating an image of pigment-encapsulating resin particles of Example 1, observed with a transmission electron microscope;

FIG. 3B is a diagram illustrating an observed image of a coating film of an ink of Example 1, observed with a scanning electron microscope;

FIG. 3C is a diagram illustrating an image of pigment-encapsulating resin particles of Comparative Example 1, observed with a transmission electron microscope,

FIG. 3D is a diagram illustrating an observed image of a coating film of an ink of Comparative Example 1, observed with a scanning electron microscope; and

FIG. 3E is a diagram illustrating an observed image of a coating film of an ink of Comparative Example 6, observed with a scanning electron microscope.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The present disclosure can provide an ink that can obtain a high image density and produce an image excellent in scratch resistance.

### (Ink)

An ink of the present disclosure contains pigment-encapsulating resin particles encapsulating a pigment, and resin particles containing a resin different from the resin of the pigment-encapsulating resin particles. The ink may contain a surfactant, and may further contain other components as needed.

The present inventors have studied existing techniques in order to obtain a high image density and an image excellent in scratch resistance.

Existing techniques have a problem that it is difficult to form pigment-encapsulating resin particles in which a pigment is completely enclosed within resin particles, i.e., a pigment is encapsulated with a resin.

Moreover, existing techniques prepare pigment-coating resin particles in which an exposed surface of a pigment is coated with a resin. In this case, the exposed surface of the pigment is often partially not coated with the resin and exposed to the outside. For example, when a water-based ink containing such pigment-coating resin particles is printed on a recording medium and subjected to rapid drying such as drying by heating in particular, the pigment in the printed ink coating film aggregates and may increase the surface roughness of the coating film. When the surface roughness of the coating film increases, there is a problem that the image density may become lower than when the printed ink is not dried by heating, because the surface roughness causes diffused reflection of light.

Moreover, there is another problem that a coating film having a large surface roughness is typically scratchy when scratched and has a poor image durability.

Hence, existing water-based inks have a problem that it is difficult to obtain a high image density and an image excellent in scratch resistance.

The present inventors have discovered that combined use of pigment-encapsulating resin particles encapsulating a pigment and resin particles free of a pigment excellent in fixability on a recording medium can produce an ink that can obtain a high image density and produce an image excellent in scratch resistance particularly even when the image is dried by heating. That is, the present inventors have found it possible to suppress aggregation of the pigment and improve image durability even when the image is dried by heating.

### <Pigment-Encapsulating Resin Particles>

The pigment-encapsulating resin particles are particles encapsulating a pigment with a resin.

In the present disclosure, “encapsulation of a pigment” means an absence of a state that an exposed surface of the pigment appears in exposed surfaces of the resin particles.

“Absence of a state that an exposed surface of the pigment appears in exposed surfaces of the resin particles” means a state that “a pigment exposure ratio (%) in the pigment-encapsulating resin particles” calculated based on observation with a transmission electron microscope in the manner described below is 10% or lower and that the average resin thickness is 10 nm or greater, where the average resin thickness is based on resin thicknesses obtained by observing 20 or more pigment-encapsulating resin particles and measuring the distance (thickness) from the surface (periphery) of each particle to the surface of the pigment at 20 or more positions. For example, JP-2016-196621-A, JP-2002-322396-A, JP-2019-099819-A, and JP-2005-120136-A propose coated pigments and microencapsulated pigments. However, these pigments are not encapsulated with resin particles contained in resin emulsions, and are different from the pigment-encapsulating resin particles.

### [Pigment Exposure Ratio (%) in Pigment-Encapsulating Resin Particles]

First, an ink containing the pigment-encapsulating resin particles is diluted with ion-exchanged water to a solid concentration of 0.1%, to produce a sample liquid.

Next, the sample liquid (1 microliter) is poured onto a hydrophilized collodion membrane-pasted mesh (collodion membrane-pasted mesh CU150 MESH available from Nisshin-EM) with a micropipette, and then quickly sucked up with filter paper cut into a triangular shape.

Next, an EM stainer diluted ten-fold (1 microliter) is poured with a micropipette and then quickly sucked up with filter paper cut into a triangular shape.

After the resultant is dried at reduced pressure, the resultant is observed with a transmission electron microscope (JEM-2100F available from JEOL Ltd.) at an accelerating voltage of 200 kV at a magnification of ×40,000.

Five or more images each within a field of view including three or more particles having a volume-based particle diameter of 100 nm or greater are captured at arbitrary different positions, to measure three or more pigment-encapsulating resin particles in each field of view and calculate the average as a “pigment exposure ratio (%) in the pigment-encapsulating resin particles” of the sample.

Discrimination between the region of the “pigment” and the region of the “resin” in the pigment-encapsulating resin particles is based on comparison between an observed image of the “pigment” alone and an observed image of a “particle formed only of the resin” alone. Regions where the pigment is exposed are measured.

The pigment exposure ratio (%) in the pigment-encapsulating resin particles is 10% or lower and preferably 5% or lower. When the pigment exposure ratio (%) in the pigment-encapsulating resin particles is 10% or lower, it is possible to improve the effect of suppressing aggregation of the pigment and improve the image density of an image formed through drying by heating.

It is also possible to calculate the pigment exposure ratio (%) in the pigment-encapsulating resin particles by constructing a three-dimensional image of a single pigment-encapsulating resin particle. In order to construct a three-dimensional image of a single pigment-encapsulating resin particle, first, continuously tilted projected images of a single particle are captured. The captured images are subjected to 3D construction processing with a “FIJI” application of image processing software (IMAGE J), to construct a three-dimensional image of the single particle. The “area S1 of exposed surfaces of the pigment” and the “area S2 of exposed surfaces of the pigment appearing in an exposed surface of the pigment-encapsulating resin particle” in the constructed three-dimensional image are measured, to calculate the “pigment exposure ratio (%) in the pigment-encapsulating resin particle” expressed by the formula 1 below.

(S2/S1)×100 Formula 1

The pigment exposure ratio (%) in the pigment-encapsulating resin particle in the three-dimensional image of the single pigment-encapsulating resin particle is 10% or lower and preferably 5% or lower. When the pigment exposure ratio (%) in the pigment-encapsulating resin particle in the three-dimensional image of the single pigment-encapsulating resin particle is 10% or lower, it is possible to improve the effect of suppressing aggregation of the pigment and improve the image density of an image formed through drying by heating.

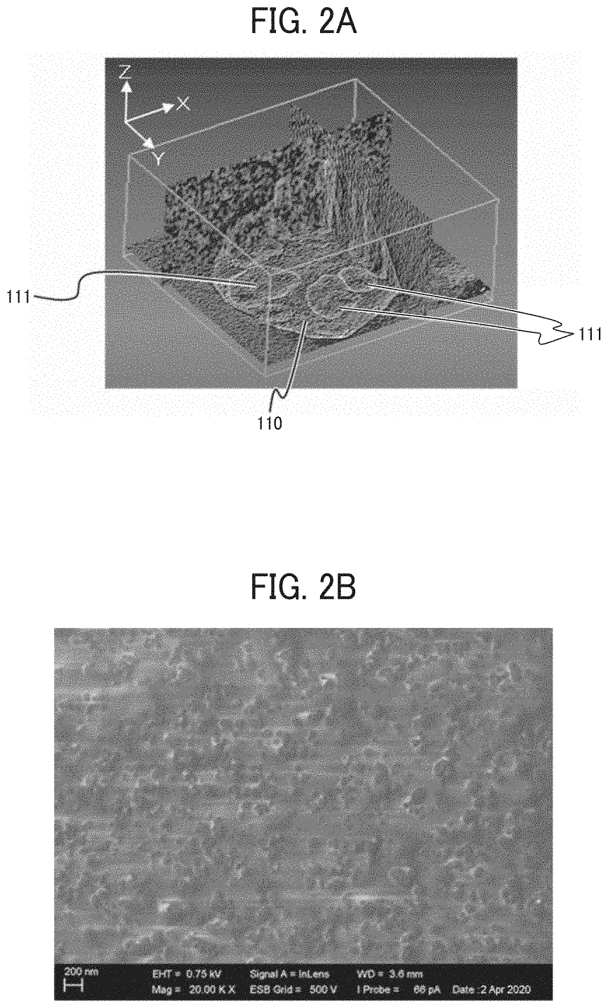

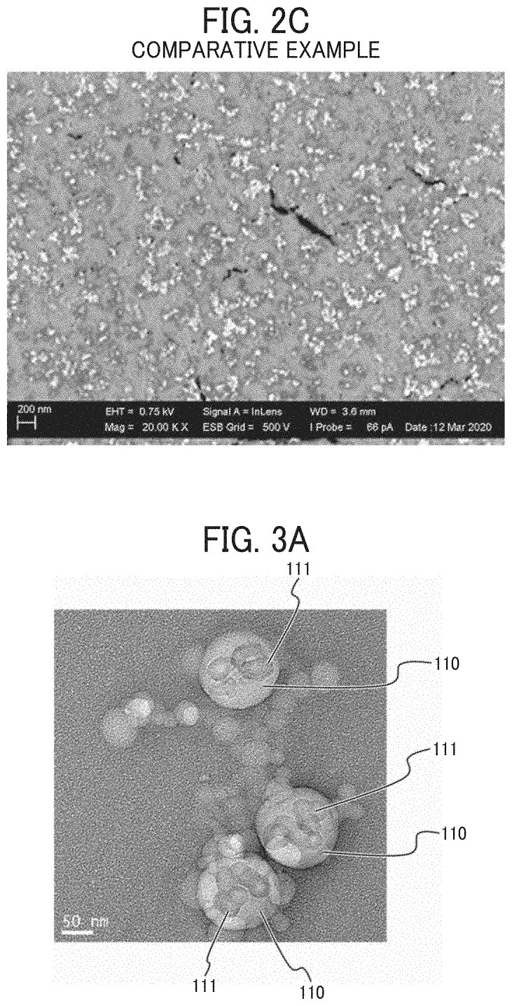

FIG. 2A is a diagram illustrating an example of the three-dimensional image constructed for a single pigment-encapsulating resin particle. As illustrated in FIG. 2A, it is possible to observe that the single pigment-encapsulating resin particle 110 encapsulates pigments 111 from the three-dimensional image constructed for the single pigment-encapsulating resin particle.

The average thickness (nm) of the resin in the pigment-encapsulating resin particles is 10 nm or greater and preferably 10 nm or greater but 50 nm or less.

It is possible to indirectly evaluate the degree of encapsulation of the pigment in the pigment-encapsulating resin particles, by determining the area of the exposed pigment relative to the area of an exposed surface of a coating film formed of a dispersion liquid (e.g., an ink, a water-based dispersion) containing the pigment-encapsulating resin particles (i.e., by determining the pigment exposure ratio in the coating film).

The coating film means a state of the ink or water-based dispersion applied over the recording medium and having dried and solidified into a film shape.

The pigment exposure ratio in the coating film can be calculated in the manner described below using, for example, a scanning electron microscope (SEM).

The ink containing the pigment-encapsulating resin particles is prepared to a solid concentration of 10.75% by mass using ion-exchanged water.

Next, the ink is applied to coated paper (LUMIART GLOSS 130, available from Stora Enso Oyj) with a 0.15 mm bar coater, and dried overnight at 25 degrees C., to form a coating film having an average thickness of 2 micrometers. The coating film is cut out and secured to a stub for SEM observation using a carbon tape. Without a conductivity imparting treatment applied, the resultant is observed with a scanning electron microscope (available from Zeiss LLC, MERLIN) at an accelerating voltage of 0.75 kV with a backscattered-electron detector at a magnification of from ×2,000 through ×20,000. By this observation method, it is possible to discern any exposed pigment based on contrast difference in the SEM image attributable to the difference in the amount of backscattered electron emission between carbon black and the resin.

For example, FIG. 2B is a diagram illustrating an example of the surface of the coating film formed of the ink containing the pigment-encapsulating resin particles of the present disclosure, observed with a scanning electron microscope. FIG. 2C is a diagram illustrating an example of a surface of a coating film formed of an ink containing: a resin-coated pigment in which a pigment is coated with a resin; and a resin emulsion, observed with a scanning electron microscope. In the scanning electron microscope images, the white portion represents the pigment region. As illustrated in FIG. 2B, when the ink containing the pigment-encapsulating resin particles of the present disclosure is used, the surface of the coating film formed is observed as having almost uniform in-plane contrasts. That is, almost no pigment regions are observed. On the other hand, as illustrated in FIG. 2C, when the pigment is coated with a resin, the surface of the coating film formed is observed as having non-uniform in-plane contrasts and having pigment regions. This means that the pigment merely coated with a resin is exposed in the surface of the coating film.

The ratio of the area occupied by the pigment in the surface of the coating film in an image observed at a magnification of ×20,000 (i.e., the pigment exposure ratio) is preferably 8% or lower, more preferably 5% or lower, and yet more preferably 0% or higher but 3% or lower. The area occupied by the pigment in the surface of the coating film can be obtained by binarization of a SEM observed image, and it is preferable to average three or more fields of view observed at arbitrary different positions. Under this observation condition, any sample that is unobservable due to charge up tends to have a low pigment exposure ratio, and such a sample is observed when the pigment exposure ratio is 3% or lower. For the binarization of a SEM observed image, an automatic binarization process when a default algorithm of the image processing software (IMAGE-J) is selected is performed.

It is preferable that the pigment-encapsulating resin particles of the present disclosure have an emulsion form. When the pigment is contained in a resin emulsion, it is possible to suppress desorption of the pigment into a medium. An emulsion means a state of particles being dispersed in a solvent such as water and an organic solvent. The particles are not particularly limited and may be appropriately selected depending on the intended purpose so long as the particles can maintain the shape of particles in a solvent used. Examples of the particles include, but are not limited to, solids and liquids.

For a single pigment-encapsulating resin particle, the distance from the periphery of the pigment-encapsulating resin particle (the surface of the particle) to the pigment (i.e., the resin thickness) is 10 nm or greater, and preferably 10 nm or greater but 50 nm or less. The distance from the periphery of the pigment-encapsulating resin particle (the surface of the particle) to the pigment (i.e., the resin thickness) is obtained by observation of 20 or more pigment-encapsulating resin particles for measurement of the thickness from the resin surface layer constituting the shell of each particle to the pigment at 20 or more positions and calculation of the average by the same method as the observation method for the “pigment exposure ratio (%) in the pigment-encapsulating resin particles”.

The shape of the pigment-encapsulating resin particles is not particularly limited and may be appropriately selected depending on the intended purpose so long as the pigment is encapsulated with the resin. Examples of the shape include, but are not limited to, spherical shapes, elliptical shapes, and indefinite shapes. Among these shapes, spherical shapes are preferable and true spheres are more preferable.

It is preferable that a single pigment-encapsulating resin particle contain two or more primary particles of the pigment. Examples of the method for confirming that a single pigment-encapsulating resin particle contains two or more primary particles of the pigment include, but are not limited to, an observation method using a transmission electron microscope. When the transmission electron microscope is used, it is possible to distinguish between the pigment and the resin in the pigment-encapsulating resin particle based on the contrast difference in the image.

By coating two or more primary particles of the pigment with the resin, it is possible to make pigment dispersion in a film dried by heating uniform and reduce surface roughness of the film. By reducing the surface roughness of the coating film, it is possible to improve the image density.

The structure of the pigment-encapsulating resin particles is not particularly limited and may be appropriately selected depending on the intended purpose so long as the pigment is encapsulated with the resin.

The aspect ratio of the pigment-encapsulating resin particles is preferably 1.0 or greater but 1.7 or less and more preferably 1.0 or greater but 1.2 or less. The aspect ratio of the pigment-encapsulating resin particles is calculated by observation of the pigment-encapsulating resin particles with the transmission electron microscope (TEM).

Specifically, a plurality of images each within a field of view including a pigment-encapsulating resin particle that is not overlapping with other particles are captured at arbitrary different observation positions, and the arbitrarily selected pigment-encapsulating resin particles are extracted by binarization using a “FIJI” application of image processing software (IMAGE J) for analyses of the particles. Twenty particles are analyzed, to calculate the ratio of the longer diameter to the shorter diameter (longer diameter/shorter diameter) of the twenty pigment-encapsulating resin particles and obtain the average (average aspect ratio) of the particles. For calculation of longer diameter/shorter diameter, the length of an axis (longer axis) of a particle extending by the longest distance from an end to an opposite end of the particle is determined as the longer diameter, and the shortest length of the particle in a direction orthogonally crossing the longer axis at the center of the longer axis is determined as the shorter diameter. When the aspect ratio of the pigment-encapsulating resin particles is 1.0 or greater but 1.7 or less, there are advantages that the smoothness of the surface of a coating film is improved and that the image density is improved.

The sphericity of the pigment-encapsulating resin particles is preferably 0.7 or greater but 1.0 or less and more preferably 0.8 or greater but 1.0 or less. A sphericity closer to 1.0 represents a shape closer to a true sphere

The sphericity is a value defined as the second power of the quotient of the product between the area of an extracted particle and 4π by the perimeter of the extracted particle. For calculation of the sphericity of the pigment-encapsulating resin particles, the pigment-encapsulating resin particles are observed according to the same observation method for the pigment-encapsulating resin particles using the transmission electron microscope (TEM) as in the method for calculating the aspect ratio of the pigment-encapsulating resin particles, to thereby measure the area of the pigment-encapsulating resin particles in the observed plane and the perimeter of the particles in the same plane.

When the sphericity of the pigment-encapsulating resin particles is 0.7 or greater but 1.0 or less, there are advantages that the smoothness of the surface of a coating film is improved and that the image density is improved.

The volume average particle diameter (D₅₀) of the pigment-encapsulating resin particles is preferably 40 nm or greater but 300 nm or less, more preferably 60 nm or greater but 200 nm or less, and yet more preferably 70 nm or greater but 150 nm or less. When the volume average particle diameter (D₅₀) of the pigment-encapsulating resin particles is 40 nm or greater, it is possible to suppress thickening and improve dispersion stability of the pigment-encapsulating resin particles. When the volume average particle diameter (D₅₀) of the pigment-encapsulating resin particles is 300 nm or less, settling of the pigment-encapsulating resin particles is suppressed and storage stability of the particles is improved.

The method for measuring the volume average particle diameter (D₅₀) of the pigment-encapsulating resin particles is not particularly limited. For example, the volume average particle diameter (D₅₀) can be measured with a laser diffraction/scattering particle diameter distribution measuring instrument (LA-960, available from Horiba, Ltd.).

A specific method for measuring the volume average particle diameter (D₅₀) of the pigment-encapsulating resin particles will be described. A sample is diluted with ion-exchanged water in a manner that the transmittance (R) and the transmittance (B) during measurement with the laser diffraction/scattering particle diameter distribution measuring instrument (LA-960, available from Horiba, Ltd.) will be from 30% through 70%. The obtained sample solution is partially poured into a batch-type cell (with a spacer of 50 micrometers). The cell is set in a sample holder for measurement.

The abundance ratio of the pigment-encapsulating resin particles in the ink is not particularly limited, and the ratio between the pigment-encapsulating resin particles and resin particles free of the pigment may be appropriately selected. The abundance of the pigment-encapsulating resin particles is a ratio of the pigment-encapsulating resin particles in all particles that have a volume-based particle diameter of 100 nm or greater in each of five or more images captured at arbitrary different positions each within a field of view including three of more particles having a volume-based particle diameter of 100 nm or greater. The average abundance calculated based on the five or more images is preferably 30% or higher and more preferably 50% or higher. When the abundance ratio of the pigment-encapsulating resin particles is 30% or higher, the image density can be increased because the abundance ratio of the pigment-encapsulating resin particles is high.

It is preferable that the pigment-encapsulating resin particles contain two or more primary particles of the pigment. Such an increased pigment density in the pigment-encapsulating resin particles can increase the image density.

### «Resin»

The resin of the pigment-encapsulating resin particles is not particularly limited and may be appropriately selected depending on the intended purpose. Examples of the resin include, but are not limited to, a self-emulsifying resin.

The self-emulsifying resin means a resin that can form an emulsified state through stirring and mixing between a resin solution and water.

Resins having a nonionic, anionic, or cationic hydrophilic group are preferable as the self-emulsifying resin. Among these resins, resins having an anionic hydrophilic group are more preferable.

Examples of the nonionic hydrophilic group include, but are not limited to, an ester group and an ether group (bond).

Examples of the anionic hydrophilic group include, but are not limited to, a carboxyl group, a carboxylate group, a sulfonic acid group, and a sulfonate group. Moreover, a carboxylate group and a sulfonate group that are at least partially neutralized with a basic compound (neutralizer) are preferable as the anionic hydrophilic group.

The neutralizer that can be used for neutralizing the anionic hydrophilic group is not particularly limited and may be appropriately selected depending on the intended purpose.

Examples of the neutralizer include, but are not limited to, organic amines such as ammonia, triethyl amine, pyridine, and morpholine, basic compounds such as alkanol amines such as monoethanol amine, and metallic basic compounds containing, for example, Na, K, Li, and Ca.

Examples of the cationic hydrophilic group include, but are not limited to, amine salts and quaternary ammonium salts.

The acid value of the resin is preferably 5 mgKOH/g or greater but 50 mgKOH/g or less and more preferably 10 mgKOH/g or greater but 30 mgKOH/g or less. When the acid value of the resin is 5 mgKOH/g or greater, the pigment-encapsulating resin particles have an excellent dispersion stability and consequently a uniform particle diameter, a good dispersibility, and a good dischargibility. When the acid value of the resin is 50 mgKOH/g or less, the particles have an appropriate hydrophilicity, an improved water resistance, and a good particle stability.

Examples of the method for measuring the acid value of the resin include, but are not limited to, a method of adding the resin in a tetrahydrofuran (THF) solution and titrating the resultant using a 0.1 M potassium hydroxide methanol solution, to measure the acid value.

The resin is not particularly limited and may be appropriately selected depending on the intended purpose. Examples of the resin include, but are not limited to, polyester resins, urethane resins, and acrylic resins. Among these resins, polyester resins are preferable.

### —Polyester Resins—

The polyester resin is obtained by polycondensation of a polyvalent alcohol with a polyvalent carboxylic acid such as polyvalent carboxylic acids, polyvalent carboxylic anhydrides, and polyvalent carboxylates or a derivative of the polyvalent carboxylic acid, or both. The polyester resin contains an aromatic unit in part or the whole of the composition. That is, the aromatic series-containing polyester contains a polyvalent alcohol, and a polyvalent carboxylic acid such as polyvalent carboxylic acids, polyvalent carboxylic anhydrides, and poly valent carboxylates or a derivative of the polyvalent carboxylic acid, or both, as the constituent components.

### —Polyvalent Alcohol Component—

Examples of the polyvalent alcohol component include, but are not limited to, divalent alcohols (diols). Specific examples include, but are not limited to, alkylene glycols containing from 2 to 36 carbon atoms (e.g., ethylene glycol, 1,2-propylene glycol, 1,3-propylene glycol, 1,4-butylene glycol, 1,6-hexanediol, and trimethylolpropane); alkylene ether glycols containing from 4 to 36 carbon atoms (e.g., diethylene glycol, triethylene glycol, dipropylene glycol, polyethylene glycol, polypropylene glycol, and polybutylene glycol); alicyclic diols containing from 6 to 36 carbon atoms (e.g., 1,4-cyclohexane dimethanol, and hydrogenated bisphenol A); adducts of the alicyclic diols with alkylene oxides [e.g., ethylene oxides (hereinafter abbreviated as “EO”), propylene oxides (hereinafter abbreviated as “PO”), and butylene oxides (hereinafter abbreviated as “BO”)] containing from 2 to 4 carbon atoms (with 1 to 30 moles added), and adducts of bisphenols (e.g., bisphenol A, bisphenol F, and bisphenol S) with alkylene oxides (e.g., EO, PO, and BO) containing from 2 to 4 carbon atoms (with 2 to 30 moles added).

The polyester resin may contain a trivalent or higher (tri- to octa-valent or higher) alcohol component in addition to the divalent diol. Specific examples of the trivalent or higher alcohol component include, but are not limited to, tri- to octa-valent or higher aliphatic polyvalent alcohols containing from 3 to 36 carbon atoms (e.g., alkane polyols and intramolecular or intermolecular dehydrated products of alkane polyols, such as glycerin, triethylolethane, trimethylolpropane, pentaerythritol, sorbitol, sorbitan, polyglycerin, and dipentaerythritol; and sugars and derivatives of sugars, such as sucrose and methyl glucoside); adducts of the aliphatic polyvalent alcohols with alkylene oxides (e.g., EP, PO, and BO) containing from 2 to 4 carbon atoms (with 1 to 30 moles added), adducts of tris phenols (e.g., tris phenol PA) with alkylene oxides (e.g., EP, PO, and BO) containing from 2 to 4 carbon atoms (with 2 to 30 moles added); and adducts of novolac resins (e.g., phenol novolac and cresol novolac, with an average degree of polymerization of from 3 through 60) with alkylene oxides (e.g., EP, PO, and BO) containing from 2 to 4 carbon atoms (with 2 to 30 moles added). One of these polyvalent alcohol components may be used alone or two or more of these polyvalent alcohol components may be used in combination.

### —Polyvalent Carboxylic Acid Component—

Examples of the polyvalent carboxylic acid component include, but are not limited to, divalent carboxylic acids (dicarboxylic acids). Specific examples include, but are not limited to, alkane dicarboxylic acids containing from 4 to 36 carbon atoms (e.g., succinic acid, adipic acid, and sebacic acid); alkenyl succinic acids (e.g., dodecenyl succinic acid); alicyclic dicarboxylic acids containing from 4 to 36 carbon atoms [e.g., dimer acid (dimerized linoleic acid)]; alkene dicarboxylic acids containing from 4 to 36 carbon atoms (e.g., maleic acid, fumaric acid, citraconic acid, and mesaconic acid); aromatic dicarboxylic acids containing from 8 to 36 carbon atoms (e.g., phthalic acid, isophthalic acid, and terephthalic acid or derivatives of these acids, and naphthalene dicarboxylic acid). One of these polyvalent carboxylic acid components may be used alone or two or more of these polyvalent carboxylic acid components may be used in combination.

Among these polyvalent carboxylic acid components, alkane dicarboxylic acid containing from 4 to 20 carbon atoms and aromatic dicarboxylic acid containing from 8 to 20 carbon atoms are preferable. Examples of the polyvalent carboxylic acid component also include, but are not limited to, acid anhydrides or lower alkyl (containing from 1 to 4 carbon atoms) esters (e.g., methyl ester, ethyl ester, and isopropyl ester) of the polyvalent carboxylic acid components described above. One of these polyvalent carboxylic acid components may be used alone or two or more of these polyvalent carboxylic acid components may be used in combination.

In addition, it is suitable to use ring-opening polymerizable systems such as polylactic acid and polycarbonate diol.

As the method for isolating the polyester resin, for example, a dispersion of the pigment-encapsulating resin particles is dried and hardened through drying by heating, and the obtained dry hard product is put in a tetrahydrofuran (THF) solution to dissolve the polyester resin. Next, the pigment contained is removed by, for example, centrifugation or filtration. Next, THF is removed. In this way, the polyester resin can be isolated. As needed, it is optional to employ recycling GPC.

The number average molecular weight (Mn), the weight average molecular weight (Mw), and the molecular weight distribution (Mw/Mn) of the polyester resin are a number average molecular weight, a weight average molecular weight, and a molecular weight distribution measured by gel permeation chromatography (GPC) regarding as a standard, a calibration curve generated using a polystyrene sample having a known molecular weight. Columns used have exclusion limits of 60,000, 20,000, and 10,000 and are used in a serially coupled state.

The molecular weight of the polyester resin is not particularly limited and may be appropriately selected depending on the intended purpose. In GPC measurement, the weight average molecular weight (Mw) of the polyester resin is preferably 2,000 or greater but 15,000 or less and more preferably 4,000 or greater but 12,000 or less.

For example, the weight average molecular weight (Mw) is measured using GPC under the conditions described below.

Instrument: GPC (available from Tosoh Corporation)

Detector: RI

Measuring temperature: 40 degrees C.

Mobile phase: tetrahydrofuran

Flow rate: 0.45 mL/min

The glass transition temperature (Tg) of the polyester resin is not particularly limited, may be appropriately selected depending on the intended purpose, and is preferably 30 degrees C. or higher but 100 degrees C. or lower and more preferably 50 degrees C. or higher but 80 degrees C. or lower.

The softening temperature of the polyester resin is not particularly limited, may be appropriately selected depending on the intended purpose, and is preferably 60 degrees C. or higher but 180 degrees C. or lower and more preferably 80 degrees C. or higher but 150 degrees C. or lower.

The molecular structure of the polyester resin can be confirmed by, for example, NMR measurement by a solution or a solid, GC/MS, LC/MS, and IR measurement.

As the method for synthesizing the polyester resin, methods hitherto commonly used may be used. For example, the following method may be used.

It is possible to synthesize the polyester resin by polycondensation of the polyvalent alcohol and the polyvalent carboxylic acid in the absence of a solvent or in the presence of an organic solvent.

### «Pigment»

Examples of the pigment include, but are not limited to, organic pigments and inorganic pigments. Among these pigments, inorganic pigments are preferable.

Examples of the inorganic pigments include, but are not limited to, titanium oxide, iron oxide, calcium carbonate, barium sulfate, aluminum hydroxide, barium yellow, cadmium red, and chromium yellow; carbon black (C.I. Pigment Black 7) manufactured by known methods such as furnace black, lamp black, acetylene black, and channel black; and metals such as copper and iron (C.I. Pigment Black 11). Among these inorganic pigments, carbon black is preferable.

The primary particle diameter of the carbon black is preferably 15 nm or greater but 100 nm or less. When the primary particle diameter of the carbon black is in the range described above, color developability is improved.

The DBP absorption of the carbon black is preferably 30 mL/100 g or greater but 150 mL/100 g or less. When the DBP absorption of the carbon black is 30 mL/100 g or greater but 150 mL/100 g or less, pigment dispersibility in a pigment pre-dispersion described below can be improved.

It is optional to use a self-dispersible pigment. The self-dispersible pigment is a pigment to which dispersion stability is imparted through incorporation of a functional group, directly or via another group of atoms, into the surface of the pigment. As the pigment before dispersion stability is imparted, hitherto known various pigments such as the pigments listed in International Publication No. WO 2009/014242 can be used.

The mass ratio (pigment/resin) between the pigment and the resin in the pigment-encapsulating resin particles is preferably 0.25 or greater but 1.0 or less and more preferably 0.3 or greater but 0.75 or less. When the mass ratio (pigment/resin) between the pigment and the resin in the pigment-encapsulating resin particles is 0.25 or greater, the image density can be improved. When the mass ratio (pigment/resin) between the pigment and the resin in the pigment-encapsulating resin particles is 1.0 or less, image durability can be improved.

Next, the method for producing the pigment-encapsulating resin particles of the ink of the present disclosure will be described in detail.

### [Method for Producing Pigment-Encapsulating Resin Particles]

The method for producing the pigment-encapsulating resin particles of the ink of the present disclosure includes a step of mixing an organic solvent and a pigment to prepare a pigment pre-dispersion (hereinafter, referred to as “pigment pre-dispersion preparing step” or “step 1”), a step of mixing the obtained pigment pre-dispersion and a resin to prepare a pigment-dispersed resin solution (hereinafter, referred to as “pigment-dispersed resin solution preparing step” or “step 2”), a step of mixing the obtained pigment-dispersed resin solution and water to prepare a pigment-encapsulating resin particle dispersion liquid (hereinafter, referred to as “pigment-encapsulating resin particle dispersion liquid preparing step” or “step 3”), and a step of removing the organic solvent from the obtained pigment-encapsulating resin particle dispersion liquid (hereinafter, referred to as “organic solvent removing step” or “step 4”), and further includes other steps as needed.

### <Pigment Pre-Dispersion Preparing Step (Step 1)>

The pigment pre-dispersion preparing step is a step of mixing an organic solvent and a pigment to prepare a pigment pre-dispersion.

The pigment is the pigment described above.

The organic solvent is not particularly limited and may be appropriately selected depending on the intended purpose so long as the organic solvent can dissolve a resin in the next pigment-dispersed resin solution preparing step. Examples of the organic solvent include, but are not limited to, ethyl acetate, methyl ethyl ketone, and acetone. Among these organic solvents, ketone-based organic solvents such as methyl ethyl ketone and acetone are preferable.

The device used in the pigment pre-dispersion preparing step is not particularly limited and may be appropriately selected depending on the intended purpose. Examples of the device include, but are not limited to, a disperser.

The volume average particle diameter (D₅₀) of the pigment in the pigment pre-dispersion is preferably 10 nm or greater but 150 nm or less and more preferably 20 nm or greater but 120 nm or less because the particle diameter of the pigment-encapsulating resin particles can be reduced.

The volume average particle diameter (D₅₀) of the pigment can be measured with, for example, a zeta potential/particle measuring system (ELSZ-1000, available from Otsuka Electronics Co., Ltd.).

Specifically, a sample is diluted with ion-exchanged water, or as needed, with an organic solvent in a manner that the solid concentration of the measurement sample will be 0.01% by mass, and the obtained solution is partially poured into a quartz cell. The cell is set in a sample holder. Measurement is performed under the following conditions: a temperature of 25 degrees C., dust cutting (number of times: 5. Upper: 5, Lower: 100), and cumulative number of times: 70.

The content of the pigment in the pigment pre-dispersion is not particularly limited and may be appropriately selected depending on the intended purpose.

It is preferable to use a pigment dispersant in the pigment pre-dispersion preparing step.

The hydrophilic or hydrophobic property of the pigment dispersant is not particularly limited and may be appropriately selected depending on the intended purpose. It is preferable to use a hydrophobic pigment dispersant because it becomes easier for the pigment to be encapsulated with the resin and the image density is improved. The hydrophilic or hydrophobic property of the pigment dispersant is determined as follows. When the pigment dispersant is insoluble in water, the pigment dispersant is hydrophobic. When the pigment dispersant is soluble in water, the pigment dispersant is hydrophilic. When the pigment dispersant is insoluble in water, an insoluble matter is visually observed when the pigment dispersant (1 g) is added in water (100 g) at 25 degrees C. and shaken. When the pigment dispersant is soluble in water, no insoluble matter is observed under the condition described above.

The pigment dispersant is not particularly limited and may be appropriately selected depending on the intended purpose.

Examples of the pigment dispersant include, but are not limited to, (meth)acrylic-based resins, styrene-(meth)acrylic-based resins, hydroxyl group-containing carboxylate, salts of polyaminoamide and acid esters, salts of polycarboxylic acid, salts of polyaminoamide and polar acid esters, unsaturated acid esters, copolymers, modified polyurethane, modified polyacrylate, polyether ester-type anionic activators, salts of naphthalenesulfonic acid formalin condensate, salts of aromatic sulfonic acid formalin condensate, polyoxyethylene alkyl phosphate, polyoxy ethylene nonylphenyl ether, and stearylamine acetate. One of these pigment dispersants may be used alone or two or more of these pigment dispersants may be used in combination.

A commercially available product can be used as the pigment dispersant. Examples of the commercially available product include, but are not limited to, JONCRYL (available from Johnson Polymer, Inc.), ANTI-TERRA-U (available from Byk-Chemie GmbH), DISPERBYK (available from Byk-Chemie GmbH), EFKA (available from Efka Chemicals GmbH), FLOWLEN (available from Kyoeisha Chemical Co., Ltd.), DISPALON (available from Kusumoto Chemicals, Ltd.), AJISPER (available from Ajinomoto Fine-Techno Co., Inc.), DEMOL (available from Kao Corporation), HOMOGENOL and EMULGEN (both available from Kao Corporation). SOLSPERSE (available from Lubrizol Corporation), and NIKKOL (available from Nikko Chemicals Co., Ltd.). One of these commercially available products may be used alone or two or more of these commercially available products may be used in combination.

The ratio between the pigment and the pigment dispersant in the pigment pre-dispersion is not particularly limited, may be appropriately selected depending on the intended purpose, and is preferably from 4:0.2 through 4:4 and more preferably from 4:0.5 through 4:3 in terms of increasing the dispersibility of the pigment pre-dispersion.

As needed, it is preferable to filter coarse particles from the pigment pre-dispersion by, for example, a filter or a centrifuge.

As the method for producing the pigment pre-dispersion, as needed, a pigment dispersant is dissolved or suspended in an organic solvent. A pigment is added to the resultant and stirred. Subsequently, the resultant is treated with a known disperser commonly used. In this way, the pigment pre-dispersion can be produced.

The disperser is not particularly limited and may be appropriately selected depending on the intended purpose. Examples of the disperser include, but are not limited to, an anchor blade, a disper blade, a homomixer, a ball mill, a roll mill, a bead mill, a sand mill, an attritor, a pearl mill, a dynomill, a high-pressure homogenizer, an ultrasonic disperser, an agitator mill, a paint shaker, a grain mill, a cobol mill, and a jet mill. Among these dispersers, a roll mill, a bead mill, a sand mill, a dynomill, a high-pressure homogenizer, and a paint shaker are preferable in terms of dispersion efficiency.

### <Pigment-Dispersed Resin Solution Preparing Step (Step 2)>

The pigment-dispersed resin solution preparing step is a step of mixing the obtained pigment pre-dispersion and a resin to prepare a pigment-dispersed resin solution.

The pigment-dispersed resin solution is obtained through mixing and stirring of the pigment pre-dispersion obtained in the pigment pre-dispersion preparing step, a resin, and as needed, a basic compound, an organic solvent, and an additive.

The resin is the resin described above.

The mixing/stirring device used in the pigment-dispersed resin solution preparing step is not particularly limited and may be appropriately selected depending on the intended purpose. Examples of the mixing/stirring device include, but are not limited to, the devices described in the pigment pre-dispersion preparing step. Among these devices, a high-speed stirrer including an anchor blade or a disper blade is suitably used in terms of uniformly stirring the high-viscosity solution and efficiently dissolving the resin powder.

The procedure for preparing the pigment-dispersed resin solution is not particularly limited. A resin solid, or a resin solid solubilized in an organic solvent may be added to the pigment pre-dispersion obtained in the pigment pre-dispersion preparing step.

It is preferable that the volume average particle diameter (D₅₀) of the pigment in the pigment-dispersed resin solution be the same volume average particle diameter (D₅₀) of the pigment in the pigment pre-dispersion obtained in the pigment pre-dispersion preparing step. It is more preferable that the volume average particle diameter (D₅₀) of the pigment do not change between the pigment pre-dispersion preparing step and the pigment-dispersed resin solution preparing step.

The resin is used for encapsulating the pigment in the pigment-encapsulating resin particle dispersion liquid preparing step. It is preferable that the resin contain a nonionic, anionic, or cationic hydrophilic group, more preferably an anionic hydrophilic group.

When the resin is an anionic resin, it is preferable to neutralize a part or the whole of the anionic group with a basic compound in order for the resin to form an emulsion in an aqueous medium and maintain dispersion stability in the aqueous medium.

The ratio of the pigment to the resin is preferably 0.2 or greater but 1.0 or less, more preferably 0.25 or greater but 1.0 or less, yet more preferably 0.25 or greater but 0.75 or less, and still more preferably 0.3 or greater but 0.6 or less. When the ratio of the pigment to the resin is 0.2 or greater, the pigment concentration is appropriate and a printed matter has a high image density. When the ratio of the pigment to the resin is 1.0 or less, most of the pigment can be encapsulated with the resin, making it possible to suppress coating film roughness through drying by heating and obtain a good image density. The ratio of the pigment to the resin can be calculated based on a preparation ratio or from a dispersion (e.g., a water dispersion and an ink) of the pigment-encapsulating resin particles to be obtained finally.

As the method for calculating the ratio of the pigment to the resin from a dispersion of the pigment-encapsulating resin particles, the ratio can be calculated by a thermal analysis of a dry hard film of the dispersion of the pigment-encapsulating resin particles using, for example, a thermogravimetric differential thermal analyzer (TG-DTA). Specifically, a dry hard film of the dispersion of the pigment-encapsulating resin particles is subjected to temperature elevation to the thermal decomposition temperature of the resin and retained at the temperature in a nitrogen gas atmosphere, and the weight of the decomposed content is calculated as the weight of the resin and the weight of the residue is calculated as the weight of the pigment. The weight of a highly heat-resistant resin that cannot be completely decomposed through a pyrolysis in a nitrogen gas atmosphere can be calculated using a calibration curve for heating loss and the ratio of the pigment to the resin. Specifically, a plurality of mixtures of the pigment and the resin mixed at arbitrary ratios are produced. Each mixture is subjected to temperature elevation to a certain temperature and retained at the temperature, to generate the calibration curve. Then, based on the ratio of weight loss obtained from the result of measuring an unknown sample, the ratio of the pigment to the resin can be calculated.

The ratio of the resin to the organic solvent in the pigment-dispersed resin solution is preferably 1.0 or greater but 3.0 or less, more preferably 1.2 or greater but 2.5 or less, and yet more preferably 1.4 or greater but 2.0 or less. When the ratio of the resin to the organic solvent is 1.1 or greater, the emulsifying speed of the resin in the step 3 will be high, making it possible for the pigment-encapsulating resin particles to have a small particle diameter. When the ratio of the resin to the organic solvent is 3.0 or less, it is possible to suppress thickening of the reaction system and improve the stirring efficiency, making it possible to suppress generation of coarse particles.

### <Pigment-Encapsulating Resin Particle Dispersion Liquid Preparing Step (Step 3)>

The pigment-encapsulating resin particle dispersion liquid preparing step is a step of mixing the obtained pigment-dispersed resin solution and water to prepare a pigment-encapsulating resin particle dispersion liquid (water dispersion liquid).

The mixing/stirring device used in the pigment-encapsulating resin particle dispersion liquid preparing step is not particularly limited and may be appropriately selected depending on the intended purpose. Examples of the mixing/stirring device include, but are not limited to, the devices described in the pigment pre-dispersion preparing step. Among these devices, a high-speed stirrer including an anchor blade or a disper blade is preferable in terms of uniform stirring of a high-viscosity solution. As a higher energy is applied for dispersion, the particle diameter of the pigment-encapsulating resin particles generated can be smaller. However, if the energy is extremely high, the pigment-encapsulating resin particles generated may be crushed and may not be able to maintain the encapsulating state.

The procedure for mixing the pigment-dispersed resin solution and water is not particularly limited, and water may be added to the pigment-dispersed resin solution or the pigment-dispersed resin solution may be added to water. It is preferable to add water to the pigment-dispersed resin solution.

The water adding rate is preferably 10 parts by mass/min or greater but 1,000 parts by mass/min or less and more preferably 30 parts by mass/min or greater but 500 parts by mass/min or less relative to 100 parts by mass of the resin. When the water adding rate is 10 parts by mass/min or greater but 1,000 parts by mass/min or less, it is possible to suppress aggregation of the pigment in the system and suppress coarsening of the pigment-encapsulating resin particles.

The amount of the water to be added is preferably 70 parts by mass or greater but 700 parts by mass or less and more preferably 100 parts by mass or greater but 500 parts by mass or less relative to 100 parts by mass of the resin used in the pigment-dispersed resin solution preparing step in terms of dispersion stability of the pigment-encapsulating resin particles.

The reaction temperature in the pigment-encapsulating resin particle dispersion liquid preparing step is preferably 20 degrees C. or higher but 80 degrees C. or lower and more preferably 30 degrees C. or higher but 60 degrees C. or lower.

### <Organic Solvent Removing Step (Step 4)>

The organic solvent removing step is a step of removing the organic solvent from the obtained pigment-encapsulating resin particle dispersion liquid. Through removal of the organic solvent from the pigment-encapsulating resin particle dispersion liquid, a water-based dispersion of the present disclosure described below is obtained.

The method for removing the organic solvent from the pigment-encapsulating resin particle dispersion liquid is not particularly limited, and a known removing device can be used. Heating at a temperature higher than or equal to the boiling point of the organic solvent in a pressure-reduced environment is preferable. Examples of the removing device include, but are not limited to, a rotary evaporator.

The pressure of the pressure-reduced environment is preferably 200 mmHg or lower and more preferably 100 mmHg or lower.

The heating temperature is preferably 20 degrees C. or higher but 80 degrees C. or lower and more preferably 30 degrees C. or higher but 60 degrees C. or lower.

As needed, coarse particles may be filtered off from the obtained water-based dispersion by, for example, a filter or a centrifuge.

### <Resin Particles>

The resin particles are resin particles free of a pigment, and contains a resin different from the resin of the pigment-encapsulating resin particles.

An appropriately synthesized product or a commercially available product may be used as the resin particles.

The resin particles are not particularly limited and may be appropriately selected depending on the intended purpose so long as the resin particles contain a resin different from the resin of the pigment-encapsulating resin particles.

Examples of the resin of the resin particles include, but are not limited to, urethane resins, polyester resins, acrylic-based resins, vinyl acetate-based resins, styrene-based resins, butadiene-based resins, styrene-butadiene-based resins, vinyl chloride-based resins, and acrylic silicone-based resins. One of these resins may be used alone or two or more of these resins may be used in combination. Among these resins, urethane resins are preferable. When the resin of the resin particles is a urethane resin, it is possible to improve fixability and durability of an image because a urethane resin has both flexibility and strength.

The volume average particle diameter of the resin particles is not particularly limited, may be appropriately selected depending on the intended purpose, and is preferably 10 nm or greater but 1,000 nm or less, more preferably 10 nm or greater but 200 nm or less, and yet more preferably 10 nm or greater but 100 nm or less in terms of obtaining a good fixability and a high image hardness. The volume average particle diameter of the resin particles can be measured with, for example, a zeta potential/particle measuring system (ELSZ-1000, available from Otsuka Electronics Co., Ltd.).

A hitherto commonly used method can be used as the method for producing the resin particles formed of the urethane resin. For example, the following method can be used.

First, in the absence of a solvent or in the presence of an organic solvent, a polymer polyol (A), a short-chain polyvalent alcohol (B), an anionic group-containing polyvalent alcohol (C), and a polyisocyanate (D) are allowed to undergo a reaction, to produce an isocyanate-terminated urethane prepolymer.

Next, the anionic group in the isocyanate-terminated urethane prepolymer is neutralized with the neutralizer as needed, and then allowed to undergo a reaction with a polyamine for a chain elongation reaction. Water is further added to the resultant, and the resultant is dispersed. Finally, the organic solvent in the system is removed as needed. In this way, the resin particles can be produced. Before the organic solvent is removed, a divalent or higher polyamine (E) (hereinafter, may also be referred to as a polyvalent amine) may be added as needed. This makes it possible to elongate or crosslink the isocyanate group at the terminal of the polyurethane segment with the polyvalent amine.

Examples of usable organic solvents include, but are not limited to, ketones such as acetone and methyl ethyl ketone; ethers such as tetrahydrofuran and dioxane; acetates such as ethyl acetate and butyl acetate; nitriles such as acetonitrile; and amides such as dimethyl formamide, N-methyl pyrrolidone, and 1-ethyl-2-pyrrolidone. One of these organic solvents may be used alone or two or more of these organic solvents may be used in combination.

As the constitution ratio, a value expressed by [mole number of C/(mole number of A+mole number of B+mole number of C)] is preferably 0.15 or greater but 0.5 or less, more preferably 0.2 or greater but 0.5 or less, and yet more preferably 0.25 or greater but 0.4 or less.

When the constitution ratio is above the range described above, excessive hydrophilicity makes an ink film significantly brittle, reduces water resistance of an image, and makes particles significantly minute to thicken the ink. On the other hand, when the constitution ratio is below the range described above, dispersion stability may be poor.

A value expressed by [equivalent number of D/(equivalent number of A+equivalent number of B+equivalent number of C)] is preferably 1.05 or greater but 1.6 or less, more preferably 1.05 or greater but 1.5 or less, and particularly preferably 1.1 or greater but 1.25 or less. In this range, it is possible to obtain a film excellent in mechanical strength and form an image excellent in scratch resistance and blocking resistance.

The hydroxyl value (OHV) of the polymer polyol (A) is preferably 20 mgKOH/g or greater but 200 mgKOH/g or less and more preferably 50 mgKOH/g or greater but 150 mgKOH/g or less. When the hydroxyl value is 20 mgKOH/g or greater but 200 mgKOH/g or less, dispersion stability is good and it is possible to obtain a urethane resin emulsion that can form an image excellent in fixability.

Examples of the polymer polyol (A) include, but are not limited to, polyether-based polymer polyol, polycarbonate-based polymer polyol, and polyester-based polyol. One of these polymer polyols may be used alone or two or more of these polymer polyols may be used in combination.

A hitherto commonly used method can be used as the method for producing the polymer polyol (A). For example, a method for producing a polyester-based polyol will be described below.

The polymer polyol is produced by polycondensation of a polyvalent alcohol with a polyvalent carboxylic acid such as polyvalent carboxylic acids, polyvalent carboxylic anhydrides, and polyvalent carboxylates or a derivative of the polyvalent carboxylic acid, or both in the absence of a solvent or in the presence of an organic solvent.

### —Polyvalent Alcohol Component—

Examples of the polyvalent alcohol component include, but are not limited to, divalent alcohols (diols). Specific examples include, but are not limited to, alkylene glycols containing from 2 to 36 carbon atoms (e.g., ethylene glycol, 1,2-propylene glycol, 1,3-propylene glycol, 1,4-butylene glycol, 1,6-hexanediol, and trimethylolpropane); alkylene ether glycols containing from 4 to 36 carbon atoms (e.g., diethylene glycol, triethylene glycol, dipropylene glycol, polyethylene glycol, polypropylene glycol, and polybutylene glycol); alicyclic diols containing from 6 to 36 carbon atoms (e.g., 1,4-cyclohexane dimethanol, and hydrogenated bisphenol A); adducts of the alicyclic diols with alkylene oxides [e.g., ethylene oxides (hereinafter abbreviated as “EO”), propylene oxides (hereinafter abbreviated as “PO”), and butylene oxides (hereinafter abbreviated as “BO”)] containing from 2 to 4 carbon atoms (with 1 to 30 moles added), and adducts of bisphenols (e.g., bisphenol A, bisphenol F, and bisphenol S) with alkylene oxides (e.g., EO, PO, and BO) containing from 2 to 4 carbon atoms (with 2 to 30 moles added).

The polymer polyol may contain a trivalent or higher (tri- to octa-valent or higher) alcohol component in addition to the divalent diol. Specific examples of the trivalent or higher alcohol component include, but are not limited to, tri- to octa-valent or higher aliphatic polyvalent alcohols containing from 3 to 36 carbon atoms (e.g., alkane polyols and intramolecular or intermolecular dehydrated products of alkane polyols, such as glycerin, triethylolethane, trimethylolpropane, pentaerythritol, sorbitol, sorbitan, polyglycerin, and dipentaerythritol; and sugars and derivatives of sugars, such as sucrose and methyl glucoside); adducts of the aliphatic polyvalent alcohols with alkylene oxides (e.g., EP, PO, and BO) containing from 2 to 4 carbon atoms (with 1 to 30 moles added); adducts of tris phenols (e.g., tris phenol PA) with alkylene oxides (e.g., EP, PO, and BO) containing from 2 to 4 carbon atoms (with 2 to 30 moles added); and adducts of novolac resins (e.g., phenol novolac and cresol novolac, with an average degree of polymerization of from 3 through 60) with alkylene oxides (e.g., EP, PO, and BO) containing from 2 to 4 carbon atoms (with 2 to 30 moles added). One of these polyvalent alcohol components may be used alone or two or more of these polyvalent alcohol components may be used in combination.

### —Polyvalent Carboxylic Acid Component—

Examples of the polyvalent carboxylic acid component include, but are not limited to, divalent carboxylic acids (dicarboxylic acids). Specific examples include, but are not limited to, alkane dicarboxylic acids containing from 4 to 36 carbon atoms (e.g., succinic acid, adipic acid, and sebacic acid): alkenyl succinic acids (e.g., dodecenyl succinic acid); alicyclic dicarboxylic acids containing from 4 to 36 carbon atoms [e.g., dimer acid (dimerized linoleic acid)]; alkene dicarboxylic acids containing from 4 to 36 carbon atoms (e.g., maleic acid, fumaric acid, citraconic acid, and mesaconic acid); aromatic dicarboxylic acids containing from 8 to 36 carbon atoms (e.g., phthalic acid, isophthalic acid, and terephthalic acid or derivatives of these acids, and naphthalene dicarboxylic acid). Among these polyvalent carboxylic acid components, alkane dicarboxylic acid containing from 4 to 20 carbon atoms and aromatic dicarboxylic acid containing from 8 to 20 carbon atoms are preferable. Examples of the polyvalent carboxylic acid component also include, but are not limited to, acid anhydrides or lower alkyl (containing from 1 to 4 carbon atoms) esters (e.g., methyl ester, ethyl ester, and isopropyl ester) of the polyvalent carboxylic acid components described above. One of these polyvalent carboxylic acid components may be used alone or two or more of these polyvalent carboxylic acid components may be used in combination.

In addition, it is suitable to use ring-opening polymerizable systems such as polylactic acid and polycarbonate diol.

The weight average molecular weight of the polymer polyol (A) is preferably 500 or greater but 15,000 or less, more preferably 500 or greater but 10,000 or less, and particularly preferably 1,000 or greater but 5,000 or less. In the numerical range described above, an ink film having a desirable glass transition temperature (Tg), an excellent strength and an excellent elasticity, and a desirable breaking energy can be obtained.

For example, the molecular weight is measured using GPC under the conditions described below.

Instrument: GPC (available from Tosoh Corporation)

Detector: RI

Measuring temperature: 40 degrees C.

Mobile phase: tetrahydrofuran

Flow rate: 0.45 mL/min

The number average molecular weight (Mn), the weight average molecular weight (Mw), and the molecular weight distribution (Mw/Mn) are a number average molecular weight, a weight average molecular weight, and a molecular weight distribution measured by gel permeation chromatography (GPC) regarding as a standard, a calibration curve generated using a polystyrene sample having a known molecular weight. Columns used have exclusion limits of 60,000, 20,000, and 10,000 and are used in a serially coupled state.

Examples of the short-chain polyvalent alcohol (B) include, but are not limited to, polyvalent alcohols containing from 2 to 15 carbon atoms, such as ethylene glycol, propylene glycol, 1,4-butanediol, 1,5-pentanediol, neopentyl glycol, 1,6-hexanediol, 1,8-octanediol, 1,4-cyclohexane dimethanol, diethylene glycol, glycerin, and trimethylolpropane.

The anionic group-containing polyvalent alcohol (C) is not particularly limited and may be appropriately selected depending on the intended purpose For example, materials that contain two or more hydroxyl groups and contain functional groups such as carboxylic acids and sulfonic acids as the anionic group can be used.

Examples of the anionic group-containing polyvalent alcohol (C) include, but are not limited to, carboxylic acid groups such as dimethylol propionic acid, dimethylol butanoic acid, dimethylol butyric acid, dimethylol valeric acid, trimethylol propionic acid, and trimethylol butanoic acid; and sulfonic acid groups such as 1,4-butanediol-2-sulfonic acid.

Examples of the polyisocyanate (D) include, but are not limited to, aromatic polyisocyanate compounds such as 1,3-phenylene diisocyanate, 1,4-phenylene diisocyanate, 2,4-tolylene diisocyanate (TDI), 2,6-tolylene diisocyanate, 4,4′-diphenylmethane diisocyanate (MDI), 2,4-diphenylmethane diisocyanate, 4,4′-diisocyanatobiphenyl, 3,3′-dimethyl-4,4′-diisocyanatobiphenyl, 3,3′-dimethyl-4,4′-diisocyanatodiphenylmethane, 1,5-naphthylene diisocyanate, 4,4′4″-triphenylmethane triisocyanate, m-isocyanatophenyl sulfonyl isocyanate, and p-isocyanatophenyl sulfonyl isocyanate; aliphatic polyisocyanate compounds such as ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl)fumarate, bis(2-isocyanatoethyl)carbonate, and 2-isocyanatoethyl-2,6-diisocyanato hexanoate; and alicyclic polyisocyanate compounds such as isophorone diisocyanate (IPDI), 4,4′-dicyclohexylmethane diisocyanate (hydrogenated MDI), cyclohexylene diisocyanate, methyl cyclohexylene diisocyanate (hydrogenated TDI), bis(2-isocyanatoethyl)-4-cyclohexene-1,2-dicarboxylate, 2,5-norbornane diisocyanate, and 2,6-norbornane diisocyanate. One of these polyisocyanates may be used alone or two or more of these polyisocyanates may be used in combination.

Among these polyisocyanates, aliphatic polyisocyanate compounds and alicyclic polyisocyanate compounds are preferable, alicyclic polyisocyanate compounds are more preferable, and isophorone diisocyanate and 4,4′-dicyclohexylmethane diisocyanate are particularly preferable.

Examples of the polyamine (E) include, but are not limited to, diamines such as ethylene diamine, 1,2-propane diamine, 1,6-hexamethylene diamine, piperazine, 2,5-dimethyl piperazine, isophorone diamine, 4,4′-dicyclohexylmethane diamine, and 1,4-cyclohexane diamine; polyamines such as diethylene triamine, dipropylene triamine, and triethylene tetramine, hydrazines such as hydrazine. N,N′-dimethyl hydrazine, and 1,6-hexamethylene bishydrazine; and dihydrazides such as succinic acid dihydrazide, adipic acid dihydrazide, glutaric acid dihydrazide, sebacic acid dihydrazide, and isophthalic acid dihydrazide.

When the urethane group content in the polyurethane segment of the resin particles contained in the ink is increased, a high cohesive force attributable to hydrogen bonding of the urethane group is obtained, and this makes it possible for the ink of the present disclosure to form a robust film excellent in both of strength and elasticity and form an image excellent in scratch resistance and blocking resistance.

For example, the urethane group content can be calculated according to the formula below.

100×(total number of moles of hydroxyl group-containing compound)×(molecular weight of urethane group/total mass of urethane resin solid content)

“Total number of moles of hydroxyl group-containing compound” is measured according to JIS K 6806.

It is preferable that the polyurethane resin particles contain a chemical crosslink attributable to a covalent bond in the molecular structure thereof, in addition to a hydrogen bond, which is one of the polyurethane's inherent characteristics. The urethane resin particles containing a chemical crosslink attributable to a covalent bond have an excellent mechanical strength, and an image highly excellent in scratch resistance and blocking resistance can be obtained finally.

Examples of the method for introducing the chemical crosslink include, but are not limited to, making the number of functional groups in the polymer polyol greater than 2, and using a trifunctional or higher short-chain polyvalent alcohol and a trifunctional or higher polyisocyanate. One of these methods may be used alone or two or more of these methods may be used in combination.

Any of the above-described methods for introducing the chemical crosslink can be suitably used. In terms of the crosslinking density, the method of making the number of functional groups in the polymer polyol greater than 2 is particularly preferable.

The number of functional groups in the polymer polyol is preferably greater than 2 but 2.5 or less and more preferably 2.02 or greater but 2.15 or less. When the number of functional groups in the polymer polyol is greater than 2 but 2.5 or less, it is possible to obtain urethane resin particles excellent in mechanical strength and form an image excellent in scratch resistance and blocking resistance.

Making the number of functional groups in the polymer polyol greater than 2 can be realized by combined use of a polymer polyol containing two functional groups and a polymer polyol containing three or more functional groups.

The number of functional groups in the entire polymer polyol when a polymer polyol containing two functional groups and a polymer polyol containing three or more functional groups are used in combination can be calculated according to the mathematical formula 2 below.

Number of functional groups in entire polymer polyol=2×a+b×(1−a) <Mathematical Formula 2>

In the mathematical formula 2, “a” represents a mass ratio of a polymer polyol containing two functional groups to the entire polymer polyol, where the mass ratio is represented by the mathematical formula 3 below, “b” represents the number of functional groups in the polymer polyol containing three or more functional groups, and “2” represents the number of functional groups in the polymer polyol containing two functional groups.

a=c/(c+d) <Mathematical formula 3>

In the mathematical formula 3, “c” represents the mass of the polymer polyol containing two functional groups, and “d” represents the mass of the polymer polyol containing three or more functional groups.

A polymer polyol containing three functional groups is preferable as the polymer polyol containing three or more functional groups.

The “number of functional groups in the entire polymer polyol” is measured according to JIS K 1557.

The urethane resin is preferably a self-emulsifying resin. It is preferable that a self-emulsifying resin contain an anionic group. Examples of the anionic group include, but are not limited to, a carboxyl group, a carboxylate group, a sulfonic acid group, and a sulfonate group. Among these anionic groups, a carboxylate group or a sulfonate group that is partially or wholly, particularly preferably wholly neutralized with, for example, a basic compound is suitable.

Examples of the neutralizer that can be used to neutralize the anionic group include, but are not limited to, basic compounds such as organic amines (e.g., ammonia, triethyl amine, pyridine, and morpholine) and alkanol amines (e.g., monoethanol amine), and metallic basic compounds containing, for example, Na, K, Li, and Ca.

The acid value of the self-emulsifying resin is preferably 5 mgKOH/g or greater but 50 mgKOH/g or less and more preferably 10 mgKOH/g or greater but 30 mgKOH/g or less. When the acid value of the self-emulsifying resin is 5 mgKOH/g or greater, the self-emulsifying resin has an excellent dispersion stability, and consequently has a uniform particle diameter, a good dispersibility, and a good dischargibility. When the acid value of the self-emulsifying resin is 50 mgKOH/g or less, the self-emulsifying resin has an appropriate hydrophilicity, an improved water resistance, and a good particle stability.

As the method for measuring the acid value, for example, polyester is put in a tetrahydrofuran (THF) solution and titrated with a 0.1 M potassium hydroxide methanol solution. In this way, the acid value can be measured.

The glass transition temperature (Tg) of the resin particles is preferably −40 degrees C. or higher but 20 degrees C. or lower. In this range, an image having a high flexibility and a high durability can be formed.

For example, the glass transition temperature is measured according the measuring method described below, using differential scanning calorimetry (DSC).

### [Measuring Method]

The resin particles are put in a petri dish and dried at 70 degrees C. for 1 hour and then at 130 degrees C. for 3 hours, to obtain a solid matter. The obtained solid matter is measured using a differential scanning calorimeter (DSC) (Q2000 available from TA Instruments Inc.) according to the measuring conditions and measuring flow described below.

### (Measuring Conditions)

Sample container: a sample pan formed of aluminum (with a cap)
Sample amount: 5 mg
Reference sample pan formed of aluminum (an empty container)
Atmosphere: nitrogen (at a flow rate of 50 mL/min)

### (Measuring Flow)

Start temperature: −80 degrees C.
Temperature elevation rate: 10 degrees C./min (first temperature elevation process)
End temperature: 130 degrees C.
Retention time: 1 min
Temperature reduction rate: 10 degrees C./min
End temperature: −80 degrees C.
Retention time: 5 min
Temperature elevation rate: 10 degrees C./min (second temperature elevation process)
End temperature: 130 degrees C.

Measurement is performed under the conditions described above, to generate a graph of “amount of endotherm or exotherm” vs. “temperature”.

The characteristic inflection point observed during the first temperature elevation process is determined as the glass transition temperature Tg. The value of Tg employed is obtained from the DSC curve by a mid-point method.

The Young's modulus of a coating film of the ink is preferably 100 MPa or higher but 1,000 MPa or lower, and more preferably 100 MPa or higher but 500 MPa or lower. When the Young's modulus of a coating film of the ink is 100 MPa or higher, the coating film has an appropriate strength. When the Young's modulus of a coating film of the ink is 1,000 MPa or lower, the coating film can appropriately disperse a stress when a stress is applied to the coating film and can be suppressed from damage.

For example, the Young's modulus is measured in the manner described below using a scanning probe microscope (SPM).

First, an ink or a dispersion liquid (emulsion) containing the resin particles is applied to coated paper (LUMIART GLOSS 130) with a 0.15 mm bar coater, and dried at 25 degrees C., to obtain a coating film. The coating film is cut out and observed under the conditions described below, to calculate the Young's modulus.

Instrument: a scanning probe microscope (DIMENSION ICON available from Bruker Optik GmbH)

Cantilever: OMCL-AC160TS available from Olympus Corporation

Measuring mode: Peak Force Quantitative Nanomechanical Mapping

Observation range: a square having 1 micrometer on each side

The solid matter concentration in the ink is not particularly limited, may be appropriately selected depending on the intended purpose, and is preferably 3% by mass or greater but 20% by mass or less and more preferably 5% by mass or greater but 15% by mass or less in order to ensure discharging stability. It is possible to calculate the solid matter concentration in the ink by dividing the mass of the ink after dried by the mass of the ink before dried.

The ratio of the pigment to the total amount of the resins (the resin contained in the pigment-encapsulating resin particles+the resin particles) contained in the ink is preferably 0.3 or greater but 0.75 or less. When the ratio of the pigment to the total amount of the resins (the resin contained in the pigment-encapsulating resin particles+the resin particles) contained in the ink is 0.3 or greater, a sufficient image density can be obtained. When the ratio of the pigment to the total amount of the resins (the resin contained in the pigment-encapsulating resin particles+the resin particles) contained in the ink is 0.75 or less, the resin proportion is sufficient and fixability can be improved.

The ratio of the pigment to the total amount of the resins (the resin contained in the pigment-encapsulating resin particles+the resin particles) contained in the ink can be calculated by a thermal analysis of an ink coating film, using, for example, a thermogravimetric differential thermal analyzer (TG-DTA) as in the method for calculating the ratio of the pigment to the resin in the pigment-dispersed resin solution.

The mass ratio of the resin particles to the pigment-encapsulating resin particles (resin particles/pigment-encapsulating resin particles) can be arbitrarily set within the range of the ratio of the pigment to the total amount of the resins (the resin contained in the pigment-encapsulating resin particles+the resin particles) contained in the ink, and is preferably 0.1 or greater but 0.5 or less. When the mass ratio (resin particles/pigment-encapsulating resin particles) is 0.1 or greater, image durability can be improved. When the mass ratio (resin particles/pigment-encapsulating resin particles) is 0.5 or less, the image density is good.

The mass ratio (resin particles/pigment-encapsulating resin particles) can be calculated by, elasticity mapping in an image, using, for example, a scanning probe microscope (SPM). Specifically, a plurality of samples are produced by mixing the pigment-encapsulating resin particles and the resin particles at arbitrary ratios, and elasticity mappings are obtained using a scanning probe microscope (DIMENSION ICON available from Bruker Optik GmbH) in a measuring mode of Peak Force Quantitative Nanomechanical Mapping, to generate a calibration curve. Next, the ink is observed under the same condition, to obtain an elasticity mapping. Based on this elasticity mapping and the calibration curve, the ratio of the resin particles to the pigment-encapsulating resin particles in the ink is calculated.

### <Surfactant>

Examples of the surfactant include, but are not limited to, anionic surfactants such as alkyl benzene sulfonate, α-olefin sulfonate, and phosphate; amine salt-type cationic surfactants such as alkyl amine salt, amino alcohol fatty acid derivatives, polyamine fatty acid derivatives, and imidazoline; quaternary ammonium salt-type cationic surfactants such as alkyl trimethyl ammonium salt, dialkyl dimethyl ammonium salt, alkyl dimethyl benzyl ammonium salt, pyridinium salt, alkyl isoquinolinium salt, and benzethonium chloride; and nonionic surfactants such as fatty acid amide derivatives and polyvalent alcohol derivatives (e.g., alanine, dodecyl di(aminoethyl)glycine, di(octylaminoethyl)glycine, and N-alkyl-N,N-dimethyl ammonium betaine). Among these surfactants, anionic surfactants are preferable, and in terms of enhancing dispersion stability, alkyl benzene sulfonate is more preferable.

Examples of the surfactant are silicone-based surfactants, fluorosurfactants, amphoteric surfactants, nonionic surfactants, anionic surfactants, etc.

The silicone-based surfactant has no specific limit and can be suitably selected to suit to a particular application. Of these, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl siloxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These are particularly preferable because they do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactants have no particular limit and can be suitably selected to suit to a particular application. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group as a modifying group is particularly preferable because such a surfactant demonstrates good characteristics as an aqueous surfactant.

Any suitably synthesized surfactant and any product thereof available on the market is suitable. Products available on the market are obtained from Byk Chemie Japan Co., Ltd., Shin-Etsu Chemical Co., Ltd., Dow Corning Toray Silicone Co., Ltd., NIHON EMULSION Co., Ltd., Kyoeisha Chemical Co., Ltd., etc.

The polyether-modified silicone-containing surfactant has no particular limit and can be suitably selected to suit to a particular application. Examples thereof include, but are not limited to, a compound in which the polyalkylene oxide structure represented by the following General formula S-1 is introduced into the side chain of the Si site of dimethyl polysiloxane.

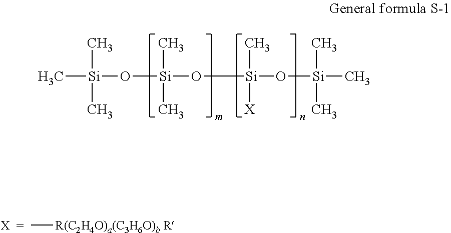

In the General formula S-1, “m”, “n”, “a”, and “b” each, respectively represent integers, R represents an alkylene group, and R′ represents an alkyl group.

Products available on the market may be used as the polyether-modified silicone-based surfactants. Specific examples of polyether-modified silicone-based surfactants include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105. FZ-2118, FZ-2154, FZ-2161, FZ-2162, FZ-2163, and FZ-2164 (all manufactured by Dow Corning Toray Silicone Co., Ltd.), BYK-33 and BYK-387 (both manufactured by Byk Chemie Japan KK.), and TSF4440, TSF4452, and TSF4453 (all manufactured by Toshiba Silicone Co., Ltd.).

A fluorosurfactant in which the number of carbon atoms replaced with fluorine atoms is from 2 to 16 and more preferably from 4 to 16 is preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because they do not foam easily and the fluorosurfactant represented by the following General formula F-1 or General formula F-2 is more preferable.

CF₃CF₂(CF₂CF₂)ₘ—CH₂CH₂O(CH₂CH₂O)ₙH General formula F-1

In General formula F-1, “m” is preferably 0 or an integer of from 1 to 10 and “n” is preferably 0 or an integer of from 1 to 40 in order to provide water solubility.

CₙF₂ₙ₊—CH₂CH(OH)CH₂—O—(CH₂CH₂O)ₐ—Y General formula F-2

In General formula F-2, Y represents H, CₘF₂ₘ₊₁, where “m” is an integer of from 1 to 6. CH₂CH(OH)CH₂—CₘF₂ₘ₊₁, where “m” represents an integer of from 4 to 6, or CₚH₂ₚ₊₁, where p represents an integer of from 1 to 19. “n” represents an integer of from 1 to 6. “a” represents an integer of from 4 to 14.

Products available on the market may be used as the fluorosurfactant.

Specific examples of the products available on the market include, but are not limited to, SURFLON S-111, SURFLON S-112, SURFLON S-113, SURFLON S-121, SURFLON S-131. SURFLON S-132, SURFLON S-141, and SURFLON S-145 (all manufactured by ASAHI GLASS CO., LTD.): FLUORAD FC-93, FC-95, FC-98, FC-129, FC-135, FC-170C, FC-430, and FC-431 (all manufactured by SUMITOMO 3M); MEGAFAC F-470, F-1405, and F-474 (all manufactured by DIC CORPORATION): ZONYL™ TBS. FSP, FSA, FSN-100, FSN, FSO-100, FSO, FS-300, UR, CAPSTONEX FS-30, FS-31, FS-3100, FS-34, and FS-35 (all manufactured by The Chemours Company): FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.), and UNIDYNE DSN-403N (manufactured by DAIKIN INDUSTRIES). Of these, FS-3100, FS-34, and FS-300 (all manufactured by The Chemours Company), FT-110, FT-250, FT-251. FT-400S, FT-150, and FT-400SW (all manufactured by NEOS COMPANY LIMITED), POLYFOX PF-151N (manufactured by OMNOVA SOLUTIONS INC.), and UNIDYNE DSN-403N (manufactured by DAIKIN INDUSTRIES) are particularly preferable in terms of good printing quality, coloring in particular, and improvement on permeation, wettability, and uniform dyeing property to paper.

The content of the surfactant is preferably 1% by mass or greater but 20% by mass or less and more preferably 2% by mass or greater but 10% by mass or less relative to the total amount of the ink.

When the content of the surfactant is in the range described above, dispersion stability is good. An ink containing a water-based dispersion in which the content of the surfactant is 20% by mass or greater has a poor discharging stability due to, for example, nozzle clogging and bent discharging.

The method for measuring the content of the surfactant in the water-based dispersion is not particularly limited and may be appropriately selected depending on the intended purpose. For example, the content of the surfactant can be measured with, a high-speed liquid chromatograph (LC-20, available from Shimadzu Corporation).

### <Other Components>

The other components are not particularly limited and may be appropriately selected depending on the intended purpose. Examples of the other components include, but are not limited to, water, an organic solvent, a defoaming agent, a preservative and a fungicide, a corrosion inhibitor, a pH regulator, an antioxidant, and an ultraviolet absorbent.

### «Water»

The water is not particularly limited and may be appropriately selected depending on the intended purpose. Examples of the water include, but are not limited to, pure water such as ion-exchanged water, ultrafiltrated water, reverse osmotic water, and distilled water, and ultrapure water.

The proportion of water in the ink has no particular limit and can be suitably selected to suit to a particular application. In terms of the drying property and discharging reliability of the ink, the proportion is preferably from 10 to 90 percent by mass and more preferably from 20 to 60 percent by mass.

### «Organic Solvent»

There is no specific limitation on the type of the organic solvent used in the present disclosure. For example, water-soluble organic solvents are suitable. Specific examples thereof include, but are not limited to, polyols, ethers such as polyol alkylethers and polyol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether: polyol arylethers such as ethylene glycol monophenylether and ethylene glycol monobenzylether: nitrogen-containing heterocyclic compounds such as 2-pyrolidone, N-methyl-2-pyrolidone, N-hydroxyethyl-2-pyrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propionamide, and 3-butoxy-N,N-dimethyl propionamide; amines such as monoethanolamine, diethanolamine, and triethylamine; sulfur-containing compounds such as dimethyl sulfoxide, sulfolane, and thiodiethanol; propylene carbonate, and ethylene carbonate.

Since the water-soluble organic solvent serves as a humectant and also imparts a good drying property, it is preferable to use an organic solvent having a boiling point of 250 degrees C. or lower.

Polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyol alkylethers such as ethyleneglycol monoethylether, ethyleneglycol monobutylether, diethylene glycol monomethylether, diethyleneglycol monoethylether, diethyleneglycol monobutylether, tetraethyleneglycol monomethylether, and propyleneglycol monoethylether; and polyol arylethers such as ethyleneglycol monophenylether and ethyleneglycol monobenzylether.

The polyol compounds having eight or more carbon atoms and glycolether compounds enhance the permeability of ink when paper is used as a print medium.

The proportion of the organic solvent in ink has no particular limit and can be suitably selected to suit a particular application.

In terms of the drying property and discharging reliability of the ink, the proportion is preferably from 10 to 60 percent by mass and more preferably from 20 to 60 percent by mass.

### «Defoaming Agent»

The defoaming agent has no particular limit. For example, silicone-based defoaming agents, polyether-based defoaming agents, and aliphatic acid ester-based defoaming agents are suitable. These can be used alone or in combination. Of these, silicone-based defoaming agents are preferable to easily break foams.

### «Preservatives and Fungicides»

The preservatives and fungicides are not particularly limited. A specific example is 1,2-benzisothiazolin-3-on.

### «Corrosion Inhibitor»

The corrosion inhibitor has no particular limit. Examples thereof are acid sulfite and sodium thiosulfate.

### «pH Regulator»

The pH regulator has no particular limit. It is preferable to adjust the pH to 7 or higher. Specific examples thereof include, but are not limited to, amines such as diethanol amine and triethanol amine.

A measured value of the volume average particle diameter D₅₀ of the ink is preferably 30 nm or greater but 300 nm or less and more preferably 50 nm or greater but 200 nm or less. When a measured value of the volume average particle diameter D₅₀ of the ink is 30 nm or greater but 300 nm or less, discharging stability and image quality such as image density can be improved. It is possible to obtain a measured value of the volume average particle diameter D₅₀ of the ink by measuring the ink with a particle size analyzer (NANOTRAC WAVE-UT151, available from MicrotracBel Corporation).

The property of the ink is not particularly limited and can be suitably selected to suit to a particular application. For example, viscosity, surface tension, pH, etc., are preferably in the following ranges.

The viscosity of the ink at 25 degrees C. is preferably from 5 to 30 mPa-s and more preferably from 5 to 25 mPa-s to improve print density and text quality and obtain good dischargibility. The viscosity can be measured by, for example, a rotatory viscometer (RE-80L, manufactured by TOKI SANGYO CO., LTD.). The measuring conditions are as follows:
Standard cone rotor (1°34′×R24)
Sample liquid amount: 1.2 mL
Number of rotations: 50 rotations per minute (rpm)
25 degrees C.
Measuring time: three minutes

The surface tension of the ink is preferably 35 mN/m or less and more preferably 32 mN/m or less at 25 degrees C. in terms that the ink is suitably levelized on a print medium and the drying time of the ink is shortened. The pH of the ink is preferably from 7 to 12 and more preferably from 8 to 11 in terms of prevention of corrosion of metal materials contacting the ink.

How to use the ink is not limited to the inkjet printing method. Specific examples of such methods other than the inkjet printing method include, but are not limited to, blade coating methods, gravure coating methods, bar coating methods, roll coating methods, dip coating methods, curtain coating methods, slide coating methods, die coating methods, and spray coating methods.

The applications of the ink of the present disclosure are not particularly limited and can be suitably selected to suit to a particular application. For example, the ink can be used for printed matter, a paint, a coating material, and foundation. The ink can be used to form two-dimensional texts and images and furthermore a three-dimensional solid object (3D modeling object) as a material for 3D modeling.

An apparatus for fabricating a three-dimensional object can be any known device with no particular limit. For example, the apparatus includes an ink container, a supplying device, and a discharging device, a drier, etc. The three-dimensional solid object includes an object manufactured by re-applying ink. In addition, the three-dimensional solid object can be manufactured by processing a structure having a substrate such as a print medium printed with the ink as a molded processed product. The molded processed product is fabricated by, for example, heating drawing or punching a structure or printed matter having a sheet-like form, film-like form, etc.

The molded processed product is suitable as a product of molding performed after surface-decoration. Examples thereof are gauges or operation panels of vehicles, office machines, electric and electronic machines, cameras, etc.

Moreover, image forming, recording, printing, etc. in the present disclosure represent the same meaning.

Recording media, media, and print media represent the same meaning.

### <Print Medium>

The print medium for use in printing is not particularly limited. Plain paper, gloss paper, special paper, cloth, etc. are usable. Also, good images can be formed on a non-permeating substrate.

The non-permeating substrate has a surface with low moisture permeability and absorbency and includes a material having myriad of hollow spaces inside but not open to the outside. To be more quantitative, the substrate has a water-absorption amount of 10 mL/m² or less between the contact and 30 msec^{1/2} after the contact according to Bristow method.

For example, plastic films of polyvinyl chloride resin, polyethylene terephthalate (PET), polypropylene, polyethylene, and polycarbonate are suitably used for the non-permeating substrate.

The print medium is not limited to articles used as typical print media. It is suitable to use building materials such as wall paper, floor material, and tiles, cloth for apparel such as T-shirts, textile, and leather as the print medium. In addition, the configuration of the paths through which the print medium is conveyed can be adjusted to accommodate ceramics, glass, metal, etc.

### (Printed Matter)

The ink printed matter of the present disclosure includes a print medium and an image formed on the print medium with the ink of the present disclosure.

An inkjet printing apparatus and an inkjet printing method are used to print the image on the print medium to obtain the printed matter.

### (Printing Apparatus and Printing Method)

The ink of the present disclosure can be suitably applied to various printing apparatuses employing an inkjet printing method such as printers, facsimile machines, photocopiers, multifunction peripherals (serving as a printer, a facsimile machine, and a photocopier), and 3D model manufacturing devices (3D printers, additive manufacturing device).

In the present disclosure, the printing apparatus and the printing method represent a device capable of discharging ink, various processing fluids, etc. to a print medium and a method printing an image on the print medium using the device. The print medium means an article to which the ink or the various processing fluids can be attached at least temporarily.

The printing apparatus may further optionally include a device relating to feeding, conveying, and ejecting the print medium and other devices referred to as a pre-processing device, a post-processing device, etc. in addition to the head portion to discharge the ink.

The printing apparatus and the printing method may further optionally include a heater for use in the heating process and a drier for use in the drying process. For example, the heating device and the drying device heat and dry the top surface and the bottom surface of a print medium having an image. The heating device and the drying device are not particularly limited. For example, a fan heater and an infra-red heater can be used. The print medium can be heated and dried before, during, and after printing.

In addition, the printing apparatus and the printing method are not limited to those producing merely meaningful visible images such as texts and figures with the ink. For example, the printing apparatus and the printing method can produce patterns like geometric design and 3D images.

In addition, the printing apparatus includes both a serial type device in which the liquid discharging head is caused to move and a line type device in which the liquid discharging head is not moved, unless otherwise specified.

Furthermore, in addition to the desktop type, this printing apparatus includes a wide type capable of printing images on a large print medium such as AO, a continuous printer capable of using continuous paper wound up in a roll form as print media.

### <Pre-Processing Fluid>

The pre-processing fluid contains a flocculant, an organic solvent, water, and optional materials such as a surfactant, a defoaming agent, a pH regulator, a preservatives and fungicides and a corrosion inhibitor.

The organic solvent, the surfactant, the defoaming agent, the pH regulator, the preservatives and fungicides, and the corrosion inhibitor can be the same material as those for use in the ink. Also, other materials for use in known processing fluid can be used.

### <Post-Processing Fluid>

The post-processing fluid has no particular limit. It is preferable that the post-processing fluid can form a transparent layer. Materials such as organic solvents, water, resins, surfactants, defoaming agents, pH regulators, preservatives and fungicides, corrosion inhibitors, etc. are suitably selected based on a necessity basis and mixed to obtain the post-processing fluid. The post-processing fluid can be applied to the entire printing area on a print medium or only the printed area.

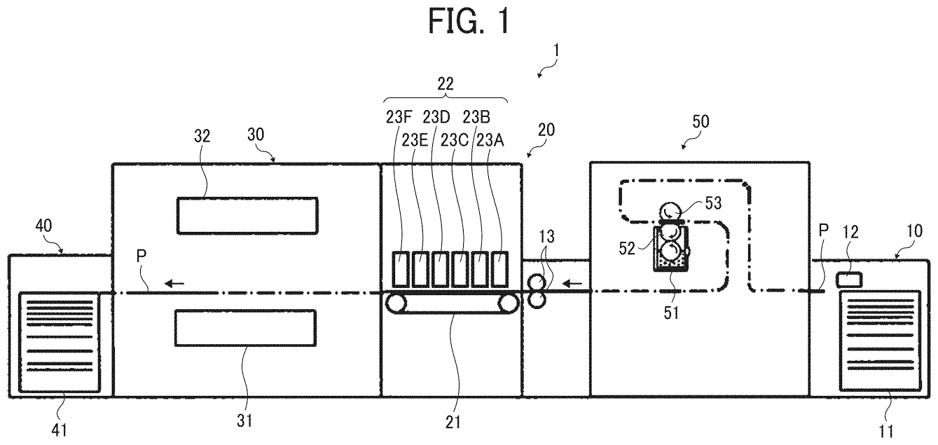

An example of the printing apparatus will be described with reference to FIG. 1. FIG. 1 is a schematic view of a printing apparatus, which is an apparatus configured to discharge a liquid.

The printing apparatus 1 includes an inlet unit 10, a pre-processing unit 50, a printing unit 20, a drying unit 30, and an outlet unit 40. In the printing apparatus 1, the pre-processing unit 50 applies a processing fluid to a sheet material P conveyed into the pre-processing unit 50 by the inlet unit 10, the printing unit 20 then applies a liquid to print a needed image, and the drying unit 30 dries the liquid attached on the sheet material P and then ejects the sheet material P to the outlet unit 40.

The inlet unit 10 includes an inlet tray 11 on which a plurality of sheet materials P are stacked, a feeding device 12 configured to send the sheet materials P one by one separately out from the inlet tray 11, and a pair of registration rollers 13 configured to send the sheet material P into the printing unit 20.

As the feeding device 12, all kinds of feeding devices can be used, such as devices using rollers and devices using air suction. After a sheet material P sent out from the inlet tray 11 by the feeding device 12 arrives by its leading end at the pair of registration rollers 13, the sheet material P is sent out into the printing unit 20 by being driven by the pair of registration rollers 13 at a predetermined timing.

The pre-processing unit 50 includes a processing fluid container 51 containing a processing fluid that is reactive with a liquid to suppress bleed of the liquid, and a rotating body for precoating treatment serving as a processing fluid applying unit configured to apply the processing fluid to a sheet material P. The rotating body for precoating treatment includes a pumping roller configured to pump up the processing fluid, an applying roller 52 configured to receive the processing fluid attached on the pumping roller and apply the processing fluid to the surface of a sheet material conveyed, and a roller 53 configured to hold a sheet material between the roller 53 and the applying roller by pressure contact against the applying roller.

After the applying roller 52 applies the processing fluid to the lower surface of a sheet material P, the sheet material P is turned upside down and conveyed to the pair of registration rollers 13 constituting the inlet unit 10.

The printing unit 20 includes a sheet conveying device 21 configured to convey a sheet material P. The sheet conveying device 21 includes a belt configured to bear a sheet material P and convey the sheet material P, and a suction device configured to generate a suction force on the surface of the belt.

The printing unit 20 also includes a liquid discharging unit 22 configured to discharge and apply a liquid to the processing fluid-applied surface of a sheet material P conveyed being borne on the belt of the sheet conveying device 21.

The liquid discharging unit 22 includes discharging units 23 (23A to 23F) serving as liquid applying units. For example, the discharging unit 23A is configured to discharge a cyan (C) liquid, the discharging unit 23B is configured to discharge a magenta (M) liquid, the discharging unit 23C is configured to discharge a yellow (Y) liquid, and the discharging unit 23D is configured to discharge a black (K) liquid. The discharging units 23E and 23F are used to discharge liquids of any of YMCK or special liquids such as white and gold (silver). It is optional to provide a discharging unit configured to discharge a processing fluid such as a surface coating liquid.

The discharging units 23 are, for example, full-line heads formed of a plurality of liquid discharging heads (hereinafter referred to simply as “heads”) including nozzle lines along which a plurality of nozzles are arranged.

The discharging operation of each discharging unit 23 of the liquid discharging unit 22 is controlled based on a drive signal corresponding to print information. When a sheet material P borne on a drum passes a region counter to the liquid discharging unit 22, the discharging units 23 discharge the liquids of the respective colors and print an image corresponding to the print information.

The sheet material P to which the liquids are applied by the liquid discharging unit 22 is passed to a suctioning/conveying mechanism unit 31 of the drying unit 30.

The drying unit 30 includes a suctioning/conveying mechanism unit 31 serving as a conveying unit configured to convey (suction and convey) a sheet material P while suctioning the sheet material P, and a drying mechanism unit 32 configured to dry the liquids on the sheet material P conveyed by the suctioning/conveying mechanism unit 31.

The sheet material P to which the liquids are applied by the printing unit 20 is dried by the drying mechanism unit 32 while being conveyed by the suctioning/conveying mechanism unit 31, and passed to the outlet unit 40.

The outlet unit 40 includes an outlet tray 41 on which a plurality of sheet materials P are stacked. A sheet material P conveyed from the drying unit 30 is sequentially stacked and retained on the outlet tray 41.

The pre-processing unit 50 is described as being configured to apply a processing fluid to one surface of a sheet material P. This is non-limiting. Another processing fluid container for applying the processing fluid to the back surface of a sheet material P may be provided downstream of the processing fluid container 51 in the conveying direction. Alternatively, a sheet material P that has passed the processing fluid container 51 may be turned upside down and passed through the processing fluid container 51 again in order that the processing fluid may be applied to the back surface of the sheet material P.

### (Water-Based Dispersion)

A water-based dispersion of the present disclosure contains water, pigment-encapsulating resin particles encapsulating a pigment, and resin particles containing a resin different from the resin of the pigment-encapsulating resin particles, and further contains other components as needed.

The water-based dispersion of the present disclosure may contain the same water, pigment-encapsulating resin particles, and resin particles as those described in the description of the ink of the present disclosure.

### (Printed Matter)

A printed matter of the present disclosure includes a coating film formed of the ink of the present disclosure or the water-based dispersion of the present disclosure, or both, and a print medium, and further includes other materials as needed.

The ink and the water-based dispersion of the printed matter of the present disclosure are the ink of the present disclosure and the water-based dispersion of the present disclosure.

The coating film means a state of the ink and the water-based dispersion applied over the print medium and having dried and solidified into a film shape.

The surface roughness of the coating film is preferably 20 nm or less and more preferably 15 nm or less. When the surface roughness of the coating film is 20 nm or less, image density degradation through drying by heating can be suppressed.

The surface roughness of the coating film is calculated using, for example, a scanning probe microscope (SPM) in the manner described below. First, the ink or the water-based dispersion containing the pigment-encapsulating resin particles is prepared to a solid concentration of 10.75% by mass using ion-exchanged water.

Next, the resultant is applied to coated paper (LUMIART GLOSS 130, available from Stora Enso Oyj) with a 0.15 mm bar coater, and dried by heating in an oven at 100 degrees C. for 5 minutes, to form a coating film having an average thickness of 2 micrometers. The coating film is cut out and observed under the conditions described below, to calculate the surface roughness. Three fields of view are observed, to calculate the average surface roughness.

### [Measuring Conditions]

Instrument: a scanning probe microscope (DIMENSION ICON available from Bruker Optik GmbH)
Cantilever: OMCL-AC240TS available from Olympus Corporation
Measuring mode: tapping mode
Observation range: a square having 2 micrometers on each side

The print medium is not particularly limited and may be appropriately selected depending on the intended purpose. Examples of the print medium include, but are not limited to permeating substrates having water permeability and non-permeating substrates having no water permeability.

The non-permeating substrate has a surface with low moisture permeability and absorbency and includes a material having myriad of hollow spaces inside but not open to the outside. To be more quantitative, the substrate has a water-absorption amount of 10 mL/m² or less between the contact and 30 msec^{1/2} after the contact according to Bristow method.

The permeating substrate means a substrate that does not satisfy the conditions of the non-permeating substrate.

Examples of the permeating substrate include, but are not limited to, plain paper, gloss paper, special paper, and cloth.

Examples of the non-permeating substrates include, but are not limited to, plastic films of vinyl chloride resin, polyethylene terephthalate (PET), polypropylene, polyethylene, and polycarbonate.

The print medium is not limited to articles used as typical print media. It is suitable to use building materials such as wall paper, floor material, and tiles, cloth for apparel such as T-shirts, textile, and leather as the print medium. In addition, the configuration of the paths through which the print medium is conveyed can be adjusted to accommodate ceramics, glass, metal, etc.

### EXAMPLES

The present disclosure will be described below by way of Examples. The present disclosure should not be construed as being limited to these Examples.

As the resins used for preparing pigment-encapsulating resin particles, a polyester resin α, which was a self-emulsifying resin, and a polyester resin β, which was a self-emulsifying resin, were synthesized in the manners described below.

### <Synthesis of Self-Emulsifying Resin: Polyester Resin α>

A 500 mL four-necked flask equipped with a nitrogen introducing pipe, a dehydrating pipe, a stirrer, and a thermocouple was charged with the materials described below, and the materials were mixed.
Adduct of bisphenol A with 2 moles of ethylene oxide (4,4′-isopropylidene bis(2-phenoxyethanol), obtained from FUJIFILM Wako Chemical Corporation, diol): 275 parts by mass
Adduct of bisphenol A with 2 moles of propylene oxide (BA-P2 glycol, obtained from Nippon Nyukazai Co., Ltd., diol): 79 parts by mass
Dimethyl isophthalate (obtained from Tokyo Chemical Industry Co., Ltd., dicarboxylic acid): 140 parts by mass
Adipic acid (obtained from Tokyo Chemical Industry Co., Ltd., dicarboxylic acid): 26 parts by mass

After the flask was sufficiently purged with a nitrogen gas internally, 300 ppm of titanium tetraisopropoxide (obtained from FUJIFILM Wako Pure Chemical Corporation) relative to the monomers (the total of the adduct of bisphenol A with 2 moles of ethylene oxide, the adduct of bisphenol A with 2 moles of propylene oxide, dimethyl isophthalate, and adipic acid) was added, and the resultant was heated to 200 degrees C. for about 4 hours under a nitrogen gas stream. Next, the resultant was heated to 230 degrees C. for 2 hours, and allowed to undergo reaction until no effluent occurred. Subsequently, the resultant was pressure-reduced to from 5 mmHg through 30 mmHg, and allowed to undergo reaction for 1 hour, to obtain a polyester resin.

The obtained polyester resin had an acid value AV of 0.5 mgKOH/g, a glass transition temperature Tg of 47 degrees C., and a weight average molecular weight Mw of 5,000.

The obtained polyester resin (160 parts by mass) was melted at 180 degrees C. under a nitrogen gas stream. Next, trimellitic anhydride (6 parts by mass) was added to the resultant, and the resultant was stirred for 40 minutes to adjust the acid value of the polyester resin, to obtain a polyester resin α having an acid value AV of 20 mgKOH/g, a glass transition temperature Tg of 51 degrees C., and a weight average molecular weight Mw of 5,100.

The “acid value AV”. “glass transition temperature Tg”, and “weight average molecular weight Mw” of the resin were measured in the manners described below.

### —Method for Measuring Acid Value AV—

In the method for measuring the acid value of the resin, the resin was put in a tetrahydrofuran (THF) solution and titrated using a 0.1 M potassium hydroxide methanol solution.

### —Method for Measuring Glass Transition Temperature Tg—

The glass transition temperature Tg was measured according the measuring method described below employing differential scanning calorimetry (DSC).

### [Measuring Method]

The resin particles were put in a petri dish, dried at 70 degrees C. for 1 hour and then at 130 degrees C. for 3 hours, to obtain a solid matter. The obtained solid matter was measured using a differential scanning calorimeter (DSC) (Q2000 obtained from TA Instruments Inc.) according to the measuring conditions and measuring flow described below.

### (Measuring Conditions)

Sample container: a sample pan formed of aluminum (with a cap)
Sample amount: 5 mg
Reference sample pan formed of aluminum (an empty container)
Atmosphere: nitrogen (at a flow rate of 50 mL/min)

### (Measuring Flow)

Start temperature: −80 degrees C.
Temperature elevation rate: 10 degrees C./min (first temperature elevation process)
End temperature: 130 degrees C.
Retention time: 1 min
Temperature reduction rate: 10 degrees C./min
End temperature: −80 degrees C.
Retention time: 5 min
Temperature elevation rate: 10 degrees C./min (second temperature elevation process)
End temperature: 130 degrees C.

Measurement was performed under the conditions described above, to generate a graph of “amount of endotherm or exotherm” vs. “temperature”.

The characteristic inflection point observed during the first temperature elevation process was determined as the glass transition temperature (Tg). The value of Tg employed was obtained from the DSC curve by a mid-point method.

### —Method for Measuring Weight Average Molecular Weight Mw—

Instrument: GPC (obtained from Tosoh Corporation)
Detector: RI
Measuring temperature: 40 degrees C.
Mobile phase: tetrahydrofuran
Flow rate: 0.45 mL/min

The weight average molecular weight (Mw) was measured by gel permeation chromatography (GPC) regarding as a standard, a calibration curve generated using a polystyrene sample having a known molecular weight. Columns used had exclusion limits of 60,000, 20,000, and 10,000 and were used in a serially coupled state.

### <Synthesis of Self-Emulsifying Resin: Polyester Resin β>

A 1 L four-necked flask equipped with a nitrogen introducing pipe, a dehydrating pipe, a stirrer, and a thermocouple was charged with the materials described below, and the materials were mixed.
Propylene glycol (obtained from Kanto Chemical Co., Ltd., diol): 280 parts by mass
Terephthalic acid (obtained from Tokyo Chemical Industry Co., Ltd., dicarboxylic acid): 611 parts by mass
Succinic acid (obtained from Tokyo Chemical Industry Co., Ltd., dicarboxylic acid): 109 parts by mass

After the flask was sufficiently purged with a nitrogen gas internally, 300 ppm of titanium tetraisopropoxide (obtained from FUJIFILM Wako Pure Chemical Corporation) relative to the monomers (the total of propylene glycol, terephthalic acid, and succinic acid) was added, and the resultant was heated to 200 degrees C. for about 4 hours under a nitrogen gas stream. Next, the resultant was heated to 230 degrees C. for 2 hours, and allowed to undergo reaction until no effluent occurred. Subsequently, the resultant was pressure-reduced to from 5 mmHg through 30 mmHg, and allowed to undergo reaction for 1 hour, to obtain a polyester resin β.

The obtained polyester resin β had an acid value AV of 19 mgKOH/g, a glass transition temperature Tg of 57 degrees C., and a weight average molecular weight Mw of 6,000.

TABLE 1

| | Polyester resin α | Polyester resin β |
|---|---|---|
| Acid value AV (mgKOH/g) | 20 | 19 |
| Glass transition temperature | 51 | 57 |
| Tg (degree C.) | | |
| Weight average molecular | 5,100 | 6,000 |
| weight Mw | | |

### Preparation Example 1

### <Preparation of Pigment-Encapsulating Resin Particles 1>

Pigment-encapsulating resin particles were prepared through the step 1 to the step 4 described below.

### —Step 1: Preparation of Pigment Pre-Dispersion A—

The materials of the prescription described below were mixed and added into a 110 mL screw tube bottle formed of glass. Subsequently, zirconia balls having a diameter of 2.0 mm (obtained from Nikkato Corporation, YTZ BALL) (170 parts by mass) were added into the bottle. The bottle was secured to a shaker (obtained from IKA Co., Ltd., VIBRAX VXR BASIC), and the materials were dispersed at 1,000 rpm for 24 hours.
Carbon black (SBX45, obtained from Asahi Carbon Co., Ltd., with a primary particle diameter of 22 nm, and DBP absorption of 55 mL/100 g): 15.0 parts by mass
Methyl ethyl ketone: 41.2 parts by mass
Pigment dispersant (AJISPER PB821, obtained from Ajinomoto Fine-Techno Co., Inc., hydrophobic): 3.8 parts by mass

Subsequently, the dispersion liquid was filtrated through a PTFE membrane filter having an average pore dimeter of 5.0 micrometers, to prepare a pigment pre-dispersion A (with a pigment solid concentration of 25% by mass). The volume average particle diameter D₅₀ of the pigment pre-dispersion A measured by a zeta potential/particle diameter measuring system (ELSZ-1000, obtained from Otsuka Electronics Co., Ltd.) was 110 nm.

The volume average particle diameter D₅₀ was measured in the manner described below.

The volume average particle diameter D₅₀ was measured according to a dynamic light scattering method using the zeta potential/particle diameter measuring system (ELSZ-1000, obtained from Otsuka Electronics Co., Ltd.).

Specifically, a sample was diluted with ion-exchanged water or, as needed, with an organic solvent in a manner that the solid concentration of the measurement sample would be 0.01% by mass and the obtained solution was partially poured into a quartz cell. The cell was set in a sample holder. Measurement was performed under the following conditions: a temperature of 25 degrees C., dust cutting (number of times: 5. Upper: 5, Lower: 100), and cumulative number of times: 70.

### —Step 2: Preparation of Pigment-Dispersed Resin Solution A—

The pigment pre-dispersion A (60 g) and the polyester resin α (30 g) were added into a 0.3 L separable flask equipped with a stirrer (THREE-ONE MOTOR, obtained from Shinto Scientific Co., Ltd.), an anchor blade, and a thermocouple in a manner that the mass ratio (P/R) between the pigment (P: Pigment, carbon black) and the polyester resin (R: Resin) would be 0.5, and mixed and stirred at 40 degrees C., to obtain a pigment-dispersed resin solution A.

—Step 3: Encapsulation of Pigment with Resin—

Methyl ethyl ketone was removed from the resultant at reduced pressure in a manner that the mass ratio (R/S) between the polyester resin α and methyl ethyl ketone (S: Solvent) would be 1.4.

Next, in order to neutralize the acid value of the polyester resin α, triethyl amine (1.1 g) in an amount equivalent to carboxyl group was added to the resultant, and the resultant was mixed and stirred for 0.5 hours. While the resultant was being stirred at a speed of 350 rpm, ion-exchanged water (64 g) was dropped into the resultant at a rate of 15 ml/min, and the resultant was stirred for 20 minutes, to prepare pigment-encapsulating resin particles encapsulating the pigment with the resin.

### —Step 4: Preparation of Water-Based Dispersion—

Next, methyl ethyl ketone was removed from the resultant by pressure-reduced evaporation with an evaporator, and the resultant was filtrated and refined through a nylon net having a mesh size of 67 micrometers.

Ion-exchanged water was added to the resultant in a manner that the solid concentration would be 30%, to obtain a water-based dispersion of pigment-encapsulating resin particles 1.

The obtained pigment-encapsulating resin particles 1 were observed with a transmission electron microscope (obtained from JEOL, Ltd., JEM-2100F) at an accelerating voltage of 200 kV at a magnification of ×40,000. As a result, the pigment-encapsulating resin particles 1 were confirmed to contain two or more primary particles of the pigment.

### (Preparation Example 2)

### <Preparation of Pigment-Encapsulating Resin Particles 2>

Pigment-encapsulating resin particles 2 were obtained in the same manner as in Preparation example 1, except that unlike in Preparation example 1, the polyester resin β was used instead of the polyester resin α to obtain a pigment-dispersed resin solution B.

The obtained pigment-encapsulating resin particles 2 were observed with a transmission electron microscope (obtained from JEOL, Ltd., JEM-2100F) at an accelerating voltage of 200 kV at a magnification of ×40,000. As a result, the pigment-encapsulating resin particles 2 were confirmed to contain two or more primary particles of the pigment.

### (Preparation Example 3)

### <Preparation of Pigment-Encapsulating Resin Particles 3>

Pigment-encapsulating resin particles 3 were obtained in the same manner as in Preparation example 1, except that unlike in Preparation example 1, a pigment pre-dispersion B prepared in the manner described below was used instead of the pigment pre-dispersion A, and the pigment pre-dispersion B (66 g) and the polyester resin α (30 g) were added together in a manner that the mass ratio (P/R) between the pigment (P: Pigment, carbon black) and the polyester resin α (R: Resin) would be 0.55, and mixed and stirred at 40 degrees C., to prepare a pigment-dispersed resin solution C.

The obtained pigment-encapsulating resin particles 3 were observed with a transmission electron microscope (obtained from JEOL, Ltd., JEM-2100F) at an accelerating voltage of 200 kV at a magnification of ×40,000. As a result, the pigment-encapsulating resin particles 3 were confirmed to contain two or more primary particles of the pigment.

### —Preparation of Pigment Pre-Dispersion B—

The materials of the prescription described below were mixed and added into a 110 mL screw tube bottle formed of glass. Subsequently, zirconia balls having a diameter of 2.0 mm (obtained from Nikkato Corporation, YTZ BALL) (170 parts by mass) were added into the bottle. The bottle was secured to a shaker (obtained from IKA Co., Ltd., VIBRAX VXR BASIC), and the materials were dispersed at 1,000 rpm for 24 hours.
Carbon black (SBX45, obtained from Asahi Carbon Co., Ltd., with a primary particle diameter of 22 nm, and DBP absorption of 55 mL/100 g): 15.0 parts by mass
Methyl ethyl ketone: 41.2 parts by mass
Pigment dispersant I (hydrophobic): 3.8 parts by mass

Subsequently, the dispersion liquid was filtered out and filtrated through a PTFE membrane filter having an average pore dimeter of 5.0 micrometers, to prepare a pigment pre-dispersion B (with a pigment solid concentration of 25% by mass). The volume average particle diameter (D₅₀) of the pigment pre-dispersion B measured by a zeta potential/particle diameter measuring system (ELSZ-1000, obtained from Otsuka Electronics Co., Ltd.) was 113 nm.

The pigment dispersant I used was prepared in the manner described below.

### —Preparation of Pigment Dispersant I—

A flask equipped with a mechanical stirrer, a thermometer, a nitrogen gas introducing pipe, and a reflux condenser was sufficiently purged with a nitrogen gas internally.

Subsequently, the materials described below were added into the flask, heated at 160 degrees C. for 8 hours, and cooled to room temperature.
12-Hydroxystearic acid (obtained from Tokyo Chemical Industry Co., Ltd.): 10.0 parts by mass
ε-Caprolactone (obtained from Tokyo Chemical Industry Co., Ltd.): 100 parts by mass
Tetrabutyl titanate (obtained from Tokyo Chemical Industry Co., Ltd.): 2.00×10⁻² parts by mass

Subsequently, polyethyleneimine (SP-200, obtained from Nippon Shokubai Co., Ltd.) (12.0 parts by mass) was added to the resultant, and the resultant was heated at 150 degrees C. for 4 hours, to obtain the pigment dispersant I.

### (Preparation Example 4)

### <Preparation of Pigment-Encapsulating Resin Particles 4>

Pigment-encapsulating resin particles 4 were obtained in the same manner as in Preparation example 3, except that unlike in Preparation example 3, the pigment pre-dispersion B (72 g) and the polyester resin α (30 g) were added together in a manner that the mass ratio (P/R) between the pigment (P: Pigment, carbon black) and the polyester resin α (R: Resin) would be 0.60, and mixed and stirred at 40 degrees C., to prepare a pigment-dispersed resin solution D.

The obtained pigment-encapsulating resin particles 4 were observed with a transmission electron microscope (obtained from JEOL, Ltd., JEM-2100F) at an accelerating voltage of 200 kV at a magnification of ×40,000. As a result, the pigment-encapsulating resin particles 4 were confirmed to contain two or more primary particles of the pigment.

### Preparation Example 5

### <Preparation of Pigment-Encapsulating Resin Particles 5>

Pigment-encapsulating resin particles 5 were obtained in the same manner as in Preparation example 1, except that unlike in Preparation example 1, the pigment pre-dispersion A (42 g) and the polyester resin α (30 g) were added together in a manner that the mass ratio (P/R) between the pigment (P: Pigment, carbon black) and the polyester resin α (R: Resin) would be 0.35, and mixed and stirred at 40 degrees C., to prepare a pigment-dispersed resin solution E.

The obtained pigment-encapsulating resin particles 5 were observed with a transmission electron microscope (obtained from JEOL, Ltd., JEM-2100F) at an accelerating voltage of 200 kV at a magnification of ×40,000. As a result, the pigment-encapsulating resin particles 5 were confirmed to contain two or more primary particles of the pigment.

### Preparation Example 6

### <Preparation of Pigment-Encapsulating Resin Particles 6>

Pigment-encapsulating resin particles 6 were obtained in the same manner as in Preparation example 1, except that unlike in Preparation example 1, the pigment pre-dispersion A (33.6 g) and the polyester resin α (30 g) were added together in a manner that the mass ratio (P/R) between the pigment (P: Pigment, carbon black) and the polyester resin α (R: Resin) would be 0.28, and mixed and stirred at 40 degrees C., to prepare a pigment-dispersed resin solution F.

The obtained pigment-encapsulating resin particles 6 were observed with a transmission electron microscope (obtained from JEOL, Ltd., JEM-2100F) at an accelerating voltage of 200 kV at a magnification of ×40,000. As a result, the pigment-encapsulating resin particles 6 were confirmed to contain two or more primary particles of the pigment.

### Preparation Example 7

### <Preparation of Pigment-Encapsulating Resin Particles 7>

Pigment-encapsulating resin particles 7 were obtained in the same manner as in Preparation example 1, except that unlike in Preparation example 1, the pigment pre-dispersion A (48 g) and the polyester resin α (30 g) were added together in a manner that the mass ratio (P/R) between the pigment (P: Pigment, carbon black) and the polyester resin α (R: Resin) would be 0.40, and mixed and stirred at 40 degrees C., to prepare a pigment-dispersed resin solution G.

The obtained pigment-encapsulating resin particles 7 were observed with a transmission electron microscope (obtained from JEOL, Ltd., JEM-2100F) at an accelerating voltage of 200 kV at a magnification of ×40,000. As a result, the pigment-encapsulating resin particles 7 were confirmed to contain two or more primary particles of the pigment.

### Preparation Example 8

### <Preparation of Pigment-Encapsulating Resin Particles 8>

Pigment-encapsulating resin particles 8 were obtained in the same manner as in Preparation example 1, except that unlike in Preparation example 1, the pigment pre-dispersion A (120 g) and the polyester resin α (30 g) were added together in a manner that the mass ratio (P/R) between the pigment (P: Pigment, carbon black) and the polyester resin α (R: Resin) would be 1.0, and mixed and stirred at 40 degrees C., to prepare a pigment-dispersed resin solution H.

The obtained pigment-encapsulating resin particles 8 were observed with a transmission electron microscope (obtained from JEOL, Ltd., JEM-2100F) at an accelerating voltage of 200 kV at a magnification of ×40,000. As a result, the pigment-encapsulating resin particles 8 were confirmed to contain two or more primary particles of the pigment.

### Preparation Example 9

### <Preparation of Pigment-Encapsulating Resin Particles 9>

Pigment-encapsulating resin particles 9 were obtained in the same manner as in Preparation example 1, except that unlike in Preparation example 1, the pigment pre-dispersion A (44.4 g) and the polyester resin α (30 g) were added together in a manner that the mass ratio (P/R) between the pigment (P: Pigment, carbon black) and the polyester resin α (R: Resin) would be 0.37, and mixed and stirred at 40 degrees C., to prepare a pigment-dispersed resin solution I.

The obtained pigment-encapsulating resin particles 9 were observed with a transmission electron microscope (obtained from JEOL, Ltd., JEM-2100F) at an accelerating voltage of 200 kV at a magnification of ×40,000. As a result, the pigment-encapsulating resin particles 9 were confirmed to contain two or more primary particles of the pigment.

### Preparation Example 10

### <Preparation of Pigment-Encapsulating Resin Particles 110>

Pigment-encapsulating resin particles 110 were obtained in the same manner as in Preparation example 1, except that unlike in Preparation example 1, the pigment pre-dispersion A (90 g) and the polyester resin α (30 g) were added together in a manner that the mass ratio (P/R) between the pigment (P: Pigment, carbon black) and the polyester resin α (R: Resin) would be 0.75, and mixed and stirred at 40 degrees C., to prepare a pigment-dispersed resin solution J.

The obtained pigment-encapsulating resin particles 110 were observed with a transmission electron microscope (obtained from JEOL, Ltd., JEM-2100F) at an accelerating voltage of 200 kV at a magnification of ×40,000. As a result, the pigment-encapsulating resin particles 110 were confirmed to contain two or more primary particles of the pigment.

“Pigment exposure ratio (%) in pigment-encapsulating resin particles”, “aspect ratio of pigment-encapsulating resin particles”, and “sphericity of pigment-encapsulating resin particles” were measured in the manners described below.

### [Pigment Exposure Ratio (%) in Pigment-Encapsulating Resin Particles]

First, an ink containing the pigment-encapsulating resin particles was diluted with ion-exchanged water to a solid concentration of 0.1%, to produce a sample liquid.

Next, the sample liquid (1 microliter) was poured onto a hydrophilized collodion membrane-pasted mesh (collodion membrane-pasted mesh, CU150 MESH obtained from Nisshin-EM) with a micropipette, and then quickly sucked up with filter paper cut into a triangular shape.

Next, an EM stainer diluted ten-fold (1 microliter) was poured with a micropipette and then quickly sucked up with filter paper cut into a triangular shape.

After the resultant was dried at reduced pressure, the resultant was observed with a transmission electron microscope (JEM-2100F obtained from JEOL Ltd.) at an accelerating voltage of 200 kV at a magnification of ×40,000.

Five or more images each within a field of view including three or more particles having a volume-based particle diameter of 100 nm or greater were captured at arbitrary different positions, to measure three or more pigment-encapsulating resin particles in each field of view and calculate the average as a “pigment exposure ratio (%) in the pigment-encapsulating resin particles” of the sample.

Discrimination between the region of the “pigment” and the region of the “resin” in the pigment-encapsulating resin particles was based on comparison between an observed image of the “pigment” alone and an observed image of a “particle formed only of the resin” alone, to measure regions.

### [Aspect Ratio of Pigment-Encapsulating Resin Particles]

The pigment-encapsulating resin particles were observed with the transmission electron microscope (TEM) described above, to calculate the aspect ratio.

Specifically, a plurality of images each within a field of view including a pigment-encapsulating resin particle that was not overlapping with other particles were captured at arbitrary different observation positions, and the arbitrarily selected pigment-encapsulating resin particles were extracted by binarization using a “FIJI” application of image processing software (IMAGE J) for analyses of the particles. Twenty particles were analyzed, to calculate the ratio of the longer diameter to the shorter diameter (longer diameter/shorter diameter) of the twenty pigment-encapsulating resin particles and obtain the average (average aspect ratio) of the particles. For calculation of longer diameter/shorter diameter, the length of an axis (longer axis) of a particle extending by the longest distance from an end to an opposite end of the particle was determined as the longer diameter, and the length of the particle in a direction orthogonally crossing the longer axis at the center of the longer axis was determined as the shorter diameter.

### [Sphericity of Pigment-Encapsulating Resin Particles]

The sphericity of the pigment-encapsulating resin particles was a value defined as the second power of the quotient of the product between the area of an extracted particle and 4π by the perimeter of the extracted particle. For calculation of the sphericity of the pigment-encapsulating resin particles, the pigment-encapsulating resin particles were observed according to the same observation method for the pigment-encapsulating resin particles using the transmission electron microscope (TEM) as in the method for calculating the aspect ratio of the pigment-encapsulating resin particles, to thereby measure the area of the pigment-encapsulating resin particles in the observed plane and the perimeter of the particles in the same plane.

TABLE 2

| | Pigment pre-dispersant A | | Pigment pre-dispersant B | |
|---|---|---|---|---|
| | | Content | | Content |
| | | (part | | (part |
| | Kind | by mass) | Kind | by mass) |
| Pigment | Carbon | 15.0 | Carbon lack | 15.0 |
| | black | | | |
| Pigment | AJISPER | 3.8 | Pigment | 3.8 |
| dispersant | PB821 | | dispersant I | |
| Solvent | Methyl | 41.2 | Methyl ethyl | 41.2 |
| | ethyl | | ketone | |
| | ketone | | | |

| | | |
|---|---|---|
| Volume | 110 | 113 |
| average | | |
| particle | | |
| diameter D₅₀ | | |
| (micrometer) | | |
| Pigment solid | 25 | 25 |
| concentration | | |
| (% by mass) | | |

TABLE 3A

| | Pigment-encapsulating resin particles | | | | |
|---|---|---|---|---|---|
| | Preparation | Preparation | Preparation | Preparation | Preparation |
| | Ex. 1 | Ex. 2 | Ex. 3 | Ex. 4 | Ex. 5 |
| Pigment pre- | A | A | B | A | A |
| dispersion | | | | | |
| Pigment- | A | B | C | D | E |
| dispersed | Polyester | Polyester | Polyester | Polyester | Polyester |
| resin | resin α | resin β | resin α | resin α | resin α |
| solution | Mass ratio | Mass ratio | Mass ratio | Mass ratio | Mass ratio |
| | (P/R):0.50 | (P/R):0.50 | (P/R):0.55 | (P/R):0.60 | (P/R):0.35 |

TABLE 3B

| | Pigment-encapsulating resin particles | | | | |
|---|---|---|---|---|---|
| | Preparation | Preparation | Preparation | Preparation | Preparation |
| | Ex. 6 | Ex. 7 | Ex. 8 | Ex. 9 | Ex. 10 |
| Pigment pre- | A | A | A | A | A |
| dispersion | | | | | |
| Pigment- | F | G | H | I | J |
| dispersed | Polyester | Polyester | Polyester | Polyester | Polyester |
| resin | resin α | resin α | resin α | resin α | resin α |
| solution | Mass ratio | Mass ratio | Mass ratio | Mass ratio | Mass ratio |
| | (PR):0.28 | (PR):0.40 | (P/R):1.0 | (PR):0.37 | (PR):0.75 |

### Example 1

### <Preparation of Ink 1>

The materials described below were mixed and filtrated through a membrane filter having an average pore diameter of 10 micrometers, to prepare an ink 1 in which the mass ratio (pigment/resin=P/R) between the pigment and resin in the ink was 0.35. The viscosity of the obtained ink at 25 degrees C. was 7.5 mPa·s.
Pigment-encapsulating resin particles 1: 8.36% by mass (a solid concentration relative to the total amount of the ink)
Resin particles a (obtained from Mitsui Chemicals, Inc., TAKELAC W6110, a urethane resin): 2.39% by mass (a solid concentration relative to the total amount of the ink)
Propylene glycol: about 40% by mass (adjusted to a viscosity of 7.5 mPa·s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Example 2

### <Preparation of Ink 2>

An ink 2 was prepared in the same manner as in Example 1, except that unlike in Example 1, the resin particles a were changed to resin particles b (obtained from Sumika Bayer Urethane Co., Ltd., BAYHYDROL UH 2648/1, a carbonate-modified urethane resin).

### Example 3

### <Preparation of Ink 3>

An ink 3 was prepared in the same manner as in Example 1, except that unlike in Example 1, the resin particles a were changed to resin particles c prepared in the manner described below.

Preparation of Resin Particles c—

The materials described below were added into a 0.3 L separable flask equipped with a stirrer (THREE-ONE MOTOR), an anchor blade, a thermocouple, and a reflux condenser, and pressured-reduced while being stirred, to remove the moisture content of the system.
Polytetramethylene oxide 1000 (obtained from FUJIFILM Wako Pure Chemical Corporation, polyether polyol): 40 g
2,2-Bis(hydroxymethyl) propionic acid (obtained from Tokyo Chemical Industry Co., Ltd.): 1.69 g

Next, while a nitrogen gas was introduced into the flask, the materials described below were added to the resultant, and the resultant was heated to 60 degrees C., and refluxed for 2 hours, to obtain a polyether-based urethane resin solution having a solid concentration of 65% by mass, an isocyanate group content ratio of 1.2% by mass, and a weight average molecular weight Mw of 3,500. The isocyanate group content ratio was measured according to JIS K 1603 (Section 1: Method for measuring an isocyanate group content ratio).
Acetone: 32 g
Triethyl amine: 1.28 g
Dicyclohexyl methane-4,4′-diisocyanato: 17.2 g
Tin (II) di-(2 ethyl hexanoate) (catalyst): 0.2 mL

Next, the obtained polyether-based urethane resin solution was heated to 40 degrees C. Subsequently, while the resultant was stirred at a speed of 500 rpm, water (112 g) was dropped into the resultant to granulate the resultant into particles. The resultant was heated and stirred for 30 minutes. Subsequently, diethylene triamine (0.8 g) was added to the resultant, and the resultant was heated and stirred for 2 hours.

Finally, acetone was evaporated from the resultant at reduced pressure, to obtain resin particles c, which were polyether-based polyurethane resin particles having a solid concentration of 30% by mass and a volume average particle diameter (D₅₀) of 93 nm. The glass transition temperature (Tg) of the obtained resin particles c after dried was −57 degrees C.

### Example 4

### <Preparation of Ink 4>

An ink 4 was prepared in the same manner as in Example 1, except that unlike in Example 1, the resin particles a were changed to resin particles d prepared in the manner escribed below.

—Preparation of Resin Particles d—

The materials described below were added into a 0.3 L separable flask equipped with a stirrer (THREE-ONE MOTOR), an anchor blade, a thermocouple, and a reflux condenser, and pressured-reduced while being stirred, to remove the moisture content of the system.
Polyester polyol resin synthesized in the manner described below: 40 g
2,2-Bis(hydroxymethyl) propionic acid (obtained from Tokyo Chemical Industry Co., Ltd.): 2.21 g

Next, while a nitrogen gas was introduced into the flask, the materials described below were added to the resultant, and the resultant was heated to 60 degrees C. and refluxed for 2 hours, to obtain a polyester-based urethane resin solution having a solid concentration of 65% by mass, an isocyanate group content ratio of 0.9% by mass, and a weight average molecular weight Mw of 5,000. The isocyanate group content ratio was measured according to JIS K 1603 (Section 1: Method for measuring an isocyanate group content ratio).
Acetone: 32.0 g
Triethyl amine: 1.67 g
Dicyclohexyl methane-4,4′-diisocyanato: 18.0 g
Tin (II) di-(2 ethyl hexanoate) (catalyst): 0.2 mL

Next, the obtained polyester-based urethane resin solution was heated to 40 degrees C. Subsequently, while the resultant was stirred at a speed of 500 rpm, water (115 g) was dropped into the resultant to granulate the resultant into particles. The resultant was heated and stirred for 30 minutes. Subsequently, diethylene triamine (0.61 g) was added to the resultant, and the resultant was heated and stirred for 2 hours.

Finally, acetone was evaporated from the resultant at reduced pressure, to obtain resin particles d, which were polyester-based polyurethane resin particles having a solid concentration of 30% by mass and a volume average particle diameter (D₅₀) of 95 nm. The glass transition temperature (Tg) of the obtained resin particles d after dried was 27 degrees C.

### —Preparation of Polyester Polyol Resin—

The materials described below were added into a 1 L four-necked flask equipped with a nitrogen introducing pipe, a dehydrating pipe, a stirrer, and a thermocouple, and mixed.
Propylene glycol (obtained from Kanto Chemical Co., Ltd., diol): 433.7 parts by mass
Dimethyl terephthalate (obtained from Tokyo Chemical Industry Co., Ltd., dicarboxylic acid): 387.4 parts by mass
Dimethyl adipate (obtained from Tokyo Chemical Industry Co., Ltd., dicarboxylic acid): 148.9 parts by mass

After the flask was sufficiently purged with a nitrogen gas internally, 300 ppm of titanium tetraisopropoxide relative to the monomers (propylene glycol, dimethyl terephthalate, and dimethyl adipate) was added to the resultant, and the resultant was heated to 200 degrees C. for about 4 hours under a nitrogen gas stream, then heated to 230 degrees C. for 2 hours, and allowed to undergo reaction until no effluent occurred. Subsequently, the resultant was allowed to undergo reaction for 30 minutes at reduced pressure of from 5 mmHg through 30 mmHg, to obtain a polyester polyol resin.

The obtained polyester polyol resin had an acid value (AV) of 0.5 mgKOH/g, a glass transition temperature (Tg) of 15 degrees C., and a weight average molecular weight (Mw) of 5,000.

The obtained polyester polyol resin (160 parts by mass) was melted at 180 degrees C. under a nitrogen gas stream. Next, trimellitic anhydride (6 parts by mass) was added to the resultant, and the resultant was stirred for 40 minutes to adjust the acid value of the resin, to obtain a polyester polyol resin having an acid value AV of 20 mgKOH/g, a glass transition temperature Tg of 17 degrees C., and a weight average molecular weight Mw of 5,100.

### Example 5

An ink 5 was prepared in the same manner as in Example 1, except that unlike in Example 1, the pigment-encapsulating resin particles 1 were changed to the pigment-encapsulating resin particles 2.

### Example 6

An ink 6 was prepared in the same manner as in Example 1, except that unlike in Example 1, the prescription was changed to as described below, and the mass ratio (pigment/resin=P/R) between the pigment and the resin in the ink was changed to 0.40.
Pigment-encapsulating resin particles 1: 9.21% by mass (a solid concentration relative to the total amount of the ink)
Resin particles a (obtained from Mitsui Chemicals, Inc., TAKELAC W6110, a urethane resin): 1.54% by mass (a solid concentration relative to the total amount of the ink)
Propylene glycol: about 40% by mass (adjusted to a viscosity of 7.5 mPa·s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Example 7

An ink 7 was prepared in the same manner as in Example 1, except that unlike in Example 1, the prescription was changed to as described below.
Pigment-encapsulating resin particles 3: 7.85% by mass (a solid concentration relative to the total amount of the ink)
Resin particles a (obtained from Mitsui Chemicals, Inc., TAKELAC W6110, a urethane resin): 3.32% by mass (a solid concentration relative to the total amount of the ink)
Propylene glycol: about 40% by mass (adjusted to a viscosity of 7.5 mPa·s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Example 8

An ink 8 was prepared in the same manner as in Example 1, except that unlike in Example 1, the prescription was changed to as described below.
Pigment-encapsulating resin particles 4: 7.43% by mass (a solid concentration relative to the total amount of the ink)
Resin particles a (obtained from Mitsui Chemicals, Inc., TAKELAC W6110, a urethane resin): 3.32% by mass (a solid concentration relative to the total amount of the ink)
Propylene glycol: about 40% by mass (adjusted to a viscosity of 7.5 mPa-s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Example 9

An ink 9 was prepared in the same manner as in Example 1, except that unlike in Example 1, the prescription was changed to as described below.
Pigment-encapsulating resin particles 6: 9.83% by mass (a solid concentration relative to the total amount of the ink)
Resin particles a (obtained from Mitsui Chemicals, Inc., TAKELAC W6110, a urethane resin): 0.92% by mass (a solid concentration relative to the total amount of the ink)
Propylene glycol: about 40% by mass (adjusted to a viscosity of 7.5 mPa·s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Example 10

An ink 10 was prepared in the same manner as in Example 1, except that unlike in Example 1, the prescription was changed to as described below.
Pigment-encapsulating resin particles 7: 9.75% by mass (a solid concentration relative to the total amount of the ink)
Resin particles a (obtained from Mitsui Chemicals, Inc., TAKELAC W6110, a urethane resin): 1.00% by mass (a solid concentration relative to the total amount of the ink)
Propylene glycol: about 40% by mass (adjusted to a viscosity of 7.5 mPa-s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Example 11

An ink 11 was prepared in the same manner as in Example 1, except that unlike in Example 1, the prescription was changed to as described below.
Pigment-encapsulating resin particles 8: 9.21% by mass (a solid concentration relative to the total amount of the ink)
Resin particles a (obtained from Mitsui Chemicals, Inc., TAKELAC W6110, a urethane resin): 1.54% by mass (a solid concentration relative to the total amount of the ink)
Propylene glycol: about 40% by mass (adjusted to a viscosity of 7.5 mPa·s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Example 12

An ink 12 was prepared in the same manner as in Example 1, except that unlike in Example 1, the prescription was changed to as described below.
Pigment-encapsulating resin particles 1: 8.36% by mass (a solid concentration relative to the total amount of the ink)
MOVINYL 5450 (obtained from Nippon Synthetic Chemical Industry Co., Ltd., a styrene acrylic resin): 2.39% by mass (a solid concentration relative to the total amount of the ink)
Propylene glycol: about 40% by mass (adjusted to a viscosity of 7.5 mPa-s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Example 13

An ink 13 was prepared in the same manner as in Example 1, except that unlike in Example 1, the prescription was changed to as described below.
Pigment-encapsulating resin particles 9: 10.32% by mass (a solid concentration relative to the total amount of the ink)
Resin particles a (obtained from Mitsui Chemicals, Inc., TAKELAC W6110, a urethane resin): 0.43% by mass (a solid concentration relative to the total amount of the ink)
Propylene glycol: about 40% by mass (adjusted to a viscosity of 7.5 mPa·s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Example 14

An ink 14 was prepared in the same manner as in Example 1, except that unlike in Example 1, the prescription was changed to as described below.
Pigment-encapsulating resin particles 110: 6.50% by mass (a solid concentration relative to the total amount of the ink)
Resin particles a (obtained from Mitsui Chemicals, Inc., TAKELAC W6110, a urethane resin): 4.25% by mass (a solid concentration relative to the total amount of the ink)
Propylene glycol: about 40% by mass (adjusted to a viscosity of 7.5 mPa-s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Comparative Example 1

An ink 15 was prepared without using the pigment-encapsulating resin particles 1 unlike in Example 1, but using resin particles e and a water-based pigment dispersion G as described below.
Resin particles e: 7.96% by mass (a solid concentration relative to the total amount of the ink)
Water-based pigment dispersion G: 2.79% by mass (a solid concentration relative to the total amount of the ink)
Propylene glycol: about 40% by mass (adjusted to a viscosity of 7.5 mPa-s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)
   —Preparation of Resin Particles e—

The materials described below were added into a 0.3 L separable flask equipped with a stirrer (THREE-ONE MOTOR), an anchor blade, a thermocouple, and a reflux condenser, and mixed and stirred at 40 degrees C., to obtain a resin solution.
Polyester resin α: 25 g
Methyl ethyl ketone: 14 g

Next, in order to neutralize the acid value of the polyester, triethyl amine (0.84 g) in an amount equivalent to carboxyl group was added to the resultant, and the resultant was stirred for 20 hours. While the resultant was being stirred at a speed of 350 rpm, ion-exchanged water (53 g) was dropped into the resultant at a rate of 15 ml/min, and the resultant was stirred for 20 minutes, to prepare resin particles.

Finally, methyl ethyl ketone was removed from the resultant by pressure-reduced evaporation with an evaporator, and the resultant was filtrated and refined through a nylon net having a mesh size of 67 micrometers.

Ion-exchanged water was added to the resultant in a manner that the solid concentration would be 30%, to obtain resin particles e having a volume average particle diameter D₅₀ of 78 nm.

### —Water-Based Pigment Dispersion G—

A pigment dispersant II (3.8 parts by mass) prepared in the manner described below was dissolved in a diethanol amine aqueous solution (30.0 parts by mass) in a manner that pH would be 8.0.

Further, ion-exchanged water was added to the resultant, to adjust the total amount of the aqueous solution to 45.0 parts by mass.

Next, the materials of the prescription described below were mixed with the resultant. The resultant was added into a 110 ml screw tube bottle formed of glass. Subsequently, zirconia balls having a diameter of 2.0 mm (obtained from Nikkato Corporation, YTZ BALL) (170 parts by mass) were added into the bottle. The bottle was secured to a shaker (obtained from IKA Co., Ltd., VIBRAX VXR BASIC), and the materials were dispersed at 1,000 rpm for 24 hours.
Carbon black (SBX45, obtained from Asahi Carbon Co): 15.0 parts by mass
Pigment dispersant II: 45.0 parts by mass

Subsequently, the dispersion liquid was filtrated through a cellulose acetate membrane filter having an average pore dimeter of 5.0 micrometers, to prepare a water-based pigment dispersion G. The volume average particle diameter D₅₀ of the water-based pigment dispersion G measured by a zeta potential/particle diameter measuring system (ELSZ-1000, obtained from Otsuka Electronics Co., Ltd.) was 120 nm.

### —Preparation of Pigment Dispersant II—

1,6-Hexanediol (obtained from Tokyo Chemical Industry Co., Ltd.) (62.0 parts by mass) was dissolved in dichloromethane (700 ml), pyridine (obtained from Tokyo Chemical Industry Co., Ltd.) (20.7 parts by mass) was added to the resultant, and the resultant was stirred. Into this solution, a solution obtained by dissolving 2-naphthalene carbonyl chloride (obtained from Tokyo Chemical Industry Co., Ltd.) in dichloromethane (100 ml) was dropped for 2 hours. Subsequently, the resultant was stirred at room temperature for 6 hours.

After the obtained solution was washed with water, an organic layer was isolated and dried with magnesium sulfate to evaporate the solvent.

The residue that survived the evaporation was refined by silica gel column chromatography using a dichloromethane/methanol (at a volume ratio of 98/2) mixture solvent as an eluent, to obtain a compound.

Next, the obtained compound (42.1 parts by mass) was dissolved in dry methyl ethyl ketone (80 ml) and heated at 60 degrees C. while being stirred.

Into this solution, a solution obtained by dissolving KARENZ MOI (obtained from Showa Denko K.K.) (24.0 parts by mass) in dry methyl ethyl ketone (20 ml) was dropped for 1 hour. Subsequently, the resultant was stirred at 70 degrees C. for 12 hours.

After the resultant was cooled to room temperature, the solvent was evaporated from the resultant.

The residue that survived the evaporation was refined by silica gel column chromatography using a dichloromethane/methanol (at volume ratio of 99/1) mixture solvent as an eluent, to obtain a monomer.

Next, acrylic acid (obtained from Tokyo Chemical Industry Co., Ltd.) (2.30 parts by mass), the monomer (8.54 g), and 2,2′-azobis(isobutyronitrile) (obtained from Tokyo Chemical Industry Co., Ltd.) (0.31 parts by mass) were dissolved in methyl ethyl ketone (100 ml), and stirred under a nitrogen gas stream at a temperature condition of 75 degrees C. for 5 hours.

Subsequently, the reaction solution cooled to room temperature was repeatedly subjected to re-precipitation five times using hexane, to refine the copolymer. After the refinement treatment, the copolymer was filtered off and dried at reduced pressure, to obtain the pigment dispersant II.

### Comparative Example 2

An ink 16 was prepared in the same manner as in Comparative Example 1, except that unlike in Comparative Example 1, the resin particles a were used instead of the resin particles e.

### Comparative Example 3

An ink 17 was prepared in the same manner as in Example 1, except that unlike in Example 1, resin particles f were used instead of the resin particles a.

—Preparation of Resin Particles f—

Resin particles f having a volume average particle diameter D₅₀ of 58 nm were obtained in the same manner as in Preparation of resin particles e, except that unlike in Preparation of resin particles e, the polyester resin R was used instead of the polyester resin α.

### Comparative Example 4

An ink 18 was prepared in the same manner as in Example 1, except that unlike in Example 1, the prescription was changed to as described below, and no resin particles were used.
Pigment-encapsulating resin particles 5: 10.75% by mass (a solid concentration relative to the total amount of the ink)
Propylene glycol: about 40% by mass (adjusted to a viscosity of 7.5 mPa·s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Comparative Example 5

An ink 19 in which the mass ratio (pigment/resin=P/R) between the pigment and the resin in the ink was 0.20 was prepared in the same manner as in Example 1, except that unlike in Example 1, the prescription was changed to as described below.
Pigment-encapsulating resin particles 5: 6.91% by mass (a solid concentration relative to the total amount of the ink)
Resin particles a (obtained from Mitsui Chemicals, Inc., TAKELAC W6110, a urethane resin): 3.84% by mass (a solid concentration relative to the total amount of the ink)
Propylene glycol: about 40% by mass (adjusted to a viscosity of 7.5 mPa·s)
Silicone-based surfactant (obtained from Nisshin Chemical Co., Ltd., SILFACE SAG503A): 1.0% by mass
Aliphatic dialcohol-based surfactant (obtained from Nisshin Chemical Co., Ltd., SURFYNOL AD01): 0.10% by mass
Water: balance (total: 100% by mass)

### Comparative Example 6

### <Preparation of Ink 21 (Styrene-Acrylic-Based Resin-Coated Black Pigment Dispersion A)>

Styrene (11.2 g), acrylic resin (2.8 g), lauryl methacrylate (12 g), polyethylene glycol methacrylate (4 g), a styrene macromer (4 g), and mercaptoethanol (0.4 g) were mixed and heated to 65 degrees C.

Next, a mixture solution of styrene (100.8 g), acrylic acid (25.2 g), lauryl methacrylate (108 g), polyethylene glycol methacrylate (36 g), hydroxyethyl methacrylate (60 g), a styrene macromer (36 g), mercaptoethanol (3.6 g), azobis methylvaleronitrile (2.4 g), and methyl ethyl ketone (18 g) was dropped into a flask for 2.5 hours.

After the dropping, a mixture solution of azobis methylvaleronitrile (0.8 g) and methyl ethyl ketone (18 g) was dropped into the flask for 0.5 hours.

After the resultant was aged at 65 degrees C. for 1 hour, azobis methylvaleronitrile (0.8 g) was added to the resultant, and the resultant was further aged for 1 hour.

After the reaction ended, methyl ethyl ketone (364 g) was added into the flask, to obtain a polymer solution A (800 g) having a solid concentration of 50%.

Next, the polymer solution A (28 g), carbon black (obtained from Cabot Corporation, BLACK PEARLS 1000) (42 g), a 1 mol/L potassium hydroxide aqueous solution (13.6 g), methyl ethyl ketone (20 g), and water (13.6 g) were sufficiently stirred and subsequently kneaded using a roll mill.

The obtained paste was added to pure water (200 g) and sufficiently stirred. Subsequently, methyl ethyl ketone was removed from the resultant with an evaporator. The resultant was subjected to pressure filtration through a polyvinylidene fluoride membrane filter having an average pore diameter of 5 micrometers, and the moisture content in the resultant was adjusted in a manner that the solid concentration would be 20%, to obtain an ink 21 (styrene-acrylic-based resin-coated black pigment dispersion A) having a solid concentration of 20%.

Next, various properties of each ink prepared were evaluated in the manners described below. The results are presented in Table 4 to Table 8.

### <Abundance Ratio of Pigment-Encapsulating Resin Particles in Ink>

First, each ink obtained was diluted with ion-exchanged water to a solid concentration of 0.1%, to produce a sample liquid.

Next, the sample liquid (1 microliter) was poured onto a hydrophilized collodion membrane-pasted mesh (collodion membrane-pasted mesh, CU150 MESH obtained from Nisshin-EM) with a micropipette, and then quickly sucked up with filter paper cut into a triangular shape.

Next, an EM stainer diluted ten-fold (1 microliter) was poured with a micropipette and then quickly sucked up with filter paper cut into a triangular shape.

After the resultant was dried at reduced pressure, the resultant was observed with a transmission electron microscope (JEM-2100F obtained from JEOL Ltd.) at an accelerating voltage of 200 kV at a magnification of ×40,000. Five or more images each within a field of view including three or more particles having a volume-based particle diameter of 100 nm or greater were captured at arbitrary different positions, to calculate the ratio of the number of pigment-encapsulating resin particles to the total number of particles having a volume-based particle diameter of 100 nm or greater in each image, and obtain the average of the images. The obtained ratio was defined as the abundance ratio of the pigment-encapsulating resin particles and evaluated according to the evaluation criteria described below.

The volume-based particle diameter was obtained by measuring the longest diameter of one particle, calculating the volume of the particle assuming that the particle was a true sphere, and multiplying the particle diameter of the particle by the volume to regard the obtained product as the volume-based particle diameter.

### [Evaluation Criteria]

B: 30% or higher

C: 10% or higher but lower than 30%

D: 0% or higher but lower than 10%

### <Pigment Exposure Ratio>

The pigment exposure ratio in the surface of a coating film was calculated by observation with a scanning electron microscope (SEM).

Specifically, first, the ink was prepared to a solid concentration of 10.75% by mass using ion-exchanged water. Next, the ink was applied to coated paper (LUMIART GLOSS 130, obtained from Stora Enso Oyj) with a 0.15 mm bar coater, and dried overnight at 25 degrees C., to form a coating film having an average thickness of 2 micrometers.

The coating film was cut out and secured to a stub for SEM observation using a carbon tape. Without a conductivity imparting treatment applied, the resultant was observed with a scanning electron microscope (obtained from Zeiss LLC, MERLIN) at an accelerating voltage of 0.75 kV with a backscattered-electron detector at a magnification of ×20,000. It would be possible to discern any exposed pigment in the surface of the coating film based on the difference in the amount of backscattered electron emission between the pigment (carbon black) and the resin.

The area occupied by the pigment in the whole coating film at a magnification of ×20,000 was defined as the pigment exposure ratio.

The ratio of the area occupied by any exposed pigment in the surface of the coating film was obtained by binarization of a SEM observed image, and the average of three fields of view observed at arbitrary different positions was employed as the ratio. For the binarization of a SEM observed image, an automatic binarization process when a default algorithm of the image processing software (IMAGE-J) was selected was performed.

The obtained pigment exposure ratio was evaluated according to the evaluation criteria described below.

### [Evaluation Criteria]

B: 5% or lower

C: Higher than 5% but 8% or lower

D: Higher than 8%

### —Image Forming Conditions—

The exterior packaging of an inkjet printer (obtained from Ricoh Company, Ltd., IPSIO GXE5500) was removed. A backside multi manual feeder was attached on the inkjet printer. Pure water was passed through the ink supplying path including the printing head to wash the ink supplying path. The washing liquid was sufficiently passed until the washing liquid would no longer be colored. The apparatus was completely drained of the washing liquid and used as a printer for evaluation.

The ink cartridge was filled with the prepared ink and used as an ink cartridge for evaluation.

A filling operation was performed to confirm that all nozzles were filled with the ink for evaluation and no abnormal image would be output. A “gloss paper-clean mode” was selected from a driver provided as an attachment of the printer, and then “color matching-off” was selected from user setting as a printing mode.

By varying the driving voltage of the head, the discharging amount of the ink was adjusted in a manner that the amount of the ink to be attached on a recording medium to form a solid image having a size of 4 cm in width and 18 cm in length in this mode would be 20 g/m².

Using these image forming conditions, “image density” and “surface roughness” described below were evaluated.

### <Image Density>

First, the ink was prepared to a solid concentration of 10.75% by mass using ion-exchanged water.

Under the image forming conditions described above, a solid image was printed on coat paper (LUMIART GLOSS 130, obtained from Stora Enso Oyj), to produce (1) an image obtained by drying the solid image at room temperature (25 degrees C.) for 1 day and (2) an image obtained by drying the solid image by heating in an oven at 100 degrees C. for 5 minutes.

In a state that white plain paper was laid below the printed image, the total density (OD) was measured by colorimetry using a spectroscopic colorimetric densitometer (X-RITE 939, obtained from X-Rite, Inc.). The value of black (K) was employed as the image density and evaluated according to the evaluation criteria described below.

### [Evaluation Criteria]

A: The OD was 2.0 or higher.

B: The OD was 1.8 or higher but lower than 2.0.

D: The OD was lower than 1.8.

### <Surface Roughness>

The image of (2) obtained by drying the solid image by heating in an oven at 100 degrees C. for 5 minutes in the measurement of the image density described above was observed with a scanning probe microscope (SPM) under the conditions described below, to calculate surface roughness (Sa arithmetic means height) according to ISO 25178.

The image was observed at arbitrary different positions, to average values measured in three fields of view to calculate an average surface roughness.

### [Measuring Conditions]

Instrument: a scanning probe microscope (DIMENSION ICON obtained from Bruker Optik GmbH)
Cantilever: OMCL-AC240TS obtained from Olympus Corporation
Measuring mode: tapping mode
Observation range: a square having 2 micrometers on each side

### <Scratch Resistance>

The image of (2) obtained by drying the solid image by heating in an oven at 100 degrees C. for 5 minutes in the measurement of the image density described above was used to evaluate scratch resistance in the manner described below.

First, the coat paper (LUMIART GLOSS 130, obtained from Stora Enso Oyj) cut into a square having 1 cm on each side was pasted to a CM-1 clock meter (obtained from Daiei Kagagu Seiki Mrf. Co., Ltd.) using a double-face tape. The clock meter was brought into contact with the printed image and moved back and forth 20 times under a load of 9 N.

Subsequently, the reflection density was measured on the coat paper cut into a square having 1 cm on each side using X-RITE 939 (obtained from X-Rite, Inc.), and subtracted from the reflection density on white paper, to calculate the transfer density of the ink transferred and evaluate the transfer density according to the evaluation criteria described below.

### [Evaluation Criteria]

A: Lower than 0.1

B: 0.1 or higher but lower than 0.2

D: 0.2 or higher

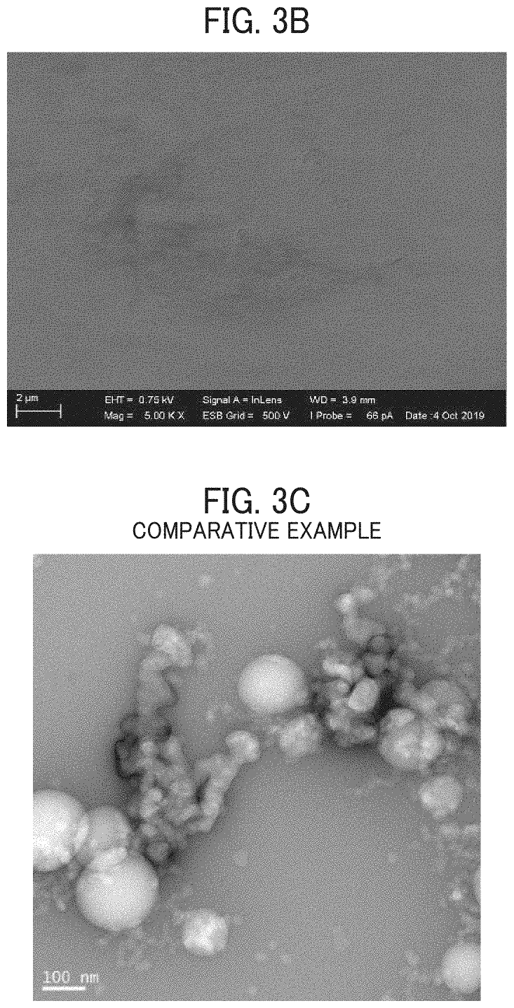

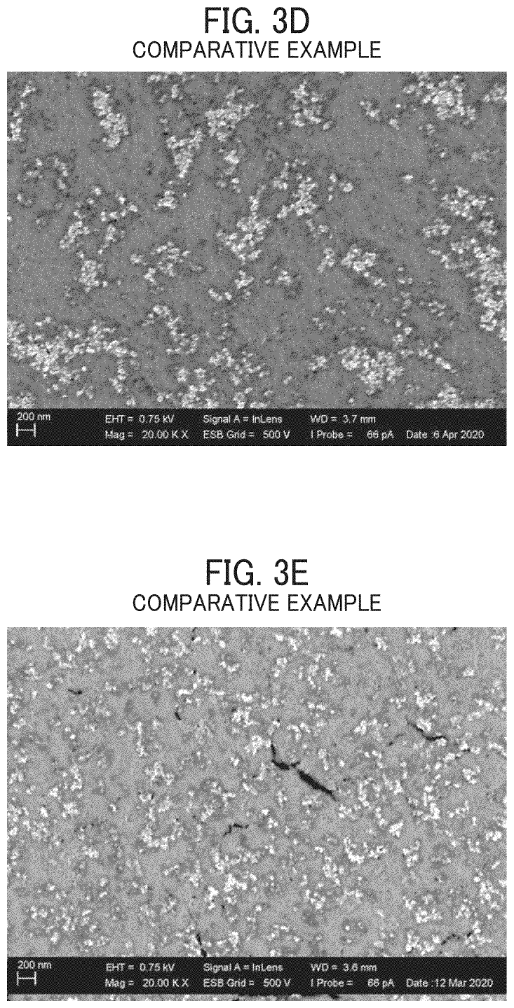

FIG. 3A is a diagram illustrating an example of an image of the pigment-encapsulating resin particles of Example 1, observed with a transmission electron microscope. FIG. 3B is a diagram illustrating an example of an observed image of a coating film of the ink of Example 1, observed with a scanning electron microscope. FIG. 3C is a diagram illustrating an example of an image of the pigment-encapsulating resin particles of Comparative Example 1, observed with a transmission electron microscope. FIG. 3D is a diagram illustrating an example of an observed image of a coating film of the ink of Comparative Example 1, observed with a scanning electron microscope. FIG. 3E is a diagram illustrating an example of an observed image of a coating film of the ink of Comparative Example 6, observed with a scanning electron microscope.

TABLE 4

| | | | Ex. | | | |
|---|---|---|---|---|---|---|
| | | | 1 | 2 | 3 | 4 |
| Pigment- | Preparation example | | 4 | 1 | 1 | 1 |
| encapsulating | Kind of resin | | Polyester resin | Polyester resin | Polyester resin | Polyester resin |
| resin particles | | | α | α | α | α |
| | Mass ratio Pigment/Resin (P/R) | | 0.50 | 0.50 | 0.50 | 0.50 |
| | Pigment exposure ratio (%) in | | 0 | 0 | 0 | 0 |
| | pigment-encapsulating resin | | | | | |
| | particles | | | | | |
| | Aspect ratio of pigment- | | 1.09 | 1.09 | 1.09 | 1.09 |
| | encapsulating resin particles | | | | | |
| | Sphericity of pigment- | | 0.88 | 0.88 | 0.88 | 0.88 |
| | encapsulating resin particles | | | | | |
| Resin particles | Name of resin particles | | a | b | c | d |
| | Kind of resin | | Polyester- | Polycarbonate- | Polyester- | Polyester- |
| | | | based urethane | based urethane | based urethane | based urethane |
| | | | resin | resin | resin | resin |
| | Tg (degree C.) | | −34 | −37 | −57 | 27 |
| | Young's modulus (mPa) | | 500 | 300 | 80 | 900 |
| Pigment alone | | | — | — | — | — |
| Ink | Ink No. | | 1 | 2 | 3 | 4 |
| prescription | Mass ratio Pigment/Resin (P/R) | | 0.35 | 0.35 | 0.35 | 0.35 |
| | in ink | | | | | |
| | Resin parlicles/Total solid | | 0.22 | 0.22 | 0.22 | 0.22 |
| | content | | | | | |
| | Resin particles/Pigment- | | 0.29 | 0.29 | 0.29 | 0.29 |
| | encapsulating resin particles | | | | | |
| Evaluation | Abundance ratio of pigment- | | B | B | B | B |
| results | encapsulating resin particles in | | | | | |
| | ink | | | | | |
| | Pigment exposure ratio (%) in | | B | B | B | B |
| | coating film | | | | | |
| | Image density | OD (25 | B | B | B | B |
| | | degrees C.) | | | | |
| | | OD (100 | A | A | B | A |
| | | degrees C.) | | | | |
| | | Surface | 6.7 | 0.7 | 9 | 4 |
| | | roughness | | | | |
| | | (nm) | | | | |
| | Scratch | Transfer OD | A | A | B | B |
| | resistance | | | | | |

TABLE 5

| | | | Ex. | | | |
|---|---|---|---|---|---|---|
| | | | 5 | 6 | 7 | 8 |
| Pigment- | Preparation example | | 2 | 1 | 3 | 4 |
| encapsulating | Kind of resin | | Polyester resin | Polyester resin | Polyester resin | Polyester resin |
| resin particles | | | β | α | α | α |
| | Mass ratio Pigment/Resin (P/R) | | 0.50 | 0.50 | 0.55 | 0.60 |
| | Pigment exposure ratio (%) in | | 0 | 0 | 0 | 0 |
| | pigment-encapsulating resin | | | | | |
| | particles | | | | | |
| | Aspect ratio of pigment- | | 1.17 | 1.09 | 1.27 | 1.29 |
| | encapsulating resin particles | | | | | |
| | Sphericity of pigment- | | 0.87 | 0.88 | 0.87 | 0.86 |
| | encapsulating resin particles | | | | | |
| Resin particles | Name of resin particles | | a | a | a | a |
| | Kind of resin | | Polyester- | Polyester- | Polyester- | Polyester- |
| | | | based urethane | based urethane | based urethane | based urethane |
| | | | resin | resin | resin | resin |
| | Tg (degree C.) | | −34 | −34 | −34 | −34 |
| | Young's modulus (mPa) | | 500 | 500 | 500 | 500 |
| Pigment alone | | | — | — | — | — |
| Ink | Ink No. | | 5 | 6 | 7 | 8 |
| prescription | Mass ratio Pigment/Resin (P/R) | | 0.35 | 0.40 | 0.35 | 0.35 |
| | in ink | | | | | |
| | Resin particles/Total solid | | 0.22 | 0.14 | 0.27 | 0.31 |
| | content | | | | | |
| | Resin particles/Pigment- | | 0.29 | 0.17 | 0.37 | 0.45 |
| | encapsulating resin particles | | | | | |
| Evaluation | Abundance ratio of pigment- | | B | B | B | B |
| results | encapsulating resin particles in | | | | | |
| | ink | | | | | |
| | Pigment exposure ratio (%) in | | B | B | B | B |
| | coating film | | | | | |
| | Image density | OD (25 | B | A | B | B |
| | | degrees C.) | | | | |
| | | OD (100 | A | A | B | B |
| | | degrees C.) | | | | |
| | | Surface | 6.5 | 6.3 | 7.2 | 7.7 |
| | | roughness | | | | |
| | | (nm) | | | | |
| | Scratch | Transfer OD | A | B | A | A |
| | resistance | | | | | |

TABLE 6

| | | | Ex. | | | |
|---|---|---|---|---|---|---|
| | | | 9 | 10 | 11 | 12 |
| Pigment- | Preparation example | | 6 | 7 | 8 | 1 |
| encapsulating | Kind of resin | | Polyester resin | Polyester resin | Polyester resin | Polyester resin |
| resin particles | | | α | α | α | α |
| | Mass ratio Pigment/Resin (P/R) | | 0.28 | 0.40 | 1.0 | 0.50 |
| | Pigment exposure ratio (%) in | | 0 | 0 | 0 | 0 |
| | pigment-encapsulating resin | | | | | |
| | particles | | | | | |
| | Aspect ratio of pigment- | | 1.05 | 1.18 | 1.38 | 1.09 |
| | encansulating resin particles | | | | | |
| | Sphericity of pigment- | | 0.92 | 0.90 | 0.80 | 0.88 |
| | encapsulating resin particles | | | | | |
| Resin particles | Name of resin particles | | a | a | a | MOVINYL |
| | | | | | | 5450 |
| | Kind of resin | | Polyester- | Polyester- | Polyester- | Styrene- |
| | | | based urethane | based urethane | based urethane | acrylic resin |
| | | | resin | resin | resin | |
| | Tg (degree C.) | | −34 | −34 | −34 | 53 |
| | Young's modulus (MPa) | | 500 | 500 | 500 | 900 |
| Pigment alone | | | — | — | — | — |
| Ink | Ink No. | | 9 | 10 | 11 | 12 |
| prescription | Mass ratio Pigment/Resin (P/R) | | 0.25 | 0.35 | 0.75 | 0.35 |
| | in ink | | | | | |
| | Resin particles/Total solid | | 0.085 | 0.093 | 0.14 | 0.22 |
| | content | | | | | |
| | Resin particles/Pigment- | | 0.094 | 0.102 | 0.17 | 0.29 |
| | encapsulating resin particles | | | | | |
| Evaluation | Abundance ratio of pigment- | | B | B | B | B |
| results | encapsulating resin particles in | | | | | |
| | ink | | | | | |
| | Pigment exposure ratio (%) in | | B | B | B | B |
| | coating film | | | | | |
| | Image density | OD (25 | B | B | A | B |
| | | degrees C.) | | | | |
| | | OD (100 | B | A | A | A |
| | | degrees C.) | | | | |
| | | Surface | 0.98 | 2.38 | 4.31 | 6.58 |
| | | roughness | | | | |
| | | (nm) | | | | |
| | Scratch | Transfer OD | B | B | B | B |
| | resistance | | | | | |

TABLE 7

| | | | Ex. | |
|---|---|---|---|---|
| | | | 13 | 14 |
| Pigment- | Preparation example | | 9 | 10 |
| encap- | Kind of resin | | Polyester resin | Polyester resin |
| sulating | | | α | α |
| resin | Mass ratio Pigment/ | | 0.37 | 0.75 |
| particles | Resin (P/R) | | | |
| | Pigment exposure | | 0 | 0 |
| | ratio (%) in | | | |
| | pigment-encapsulating | | | |
| | resin particles | | | |
| | Aspect ratio of pigment- | | 1.05 | 1.12 |
| | encapsulating resin particles | | | |
| | Sphericity of pigment- | | 0.91 | 0.86 |
| | encapsulating resin particles | | | |
| Resin | Name of resin particles | | a | a |
| particles | Kind of resin | | Polyester- | Polyester- |
| | | | based urethane | based urethane |
| | | | resin | resin |
| | Tg (degree C.) | | −34 | −34 |
| | Young's modulus | | 500 | 500 |
| | (mPa) | | | |
| Pigment alone | | | — | — |
| Ink | Ink No. | | 13 | 14 |
| pre- | Mass ratio Pigment/ | | 0.35 | 0.35 |
| scription | Resin (P/R) in ink | | | |
| | Resin particles/Total solid | | 0.04 | 0.4 |
| | content | | | |
| | Resin particles/Pigment- | | 0.042 | 0.65 |
| | encapsulating resin particles | | | |
| Evaluation | Abundance ratio of pigment- | | B | C |
| results | encapsulating resin | | | |
| | particles in ink | | | |
| | Pigment exposure ratio | | B | B |
| | (%) in coating film | | | |
| | Image | OD (25 | B | C |
| | density | degrees C.) | | |
| | | OD (100 | B | C |
| | | degrees C) | | |
| | | Surface | 5.35 | 4.88 |
| | | roughness | | |
| | | (nm) | | |
| | Scratch | Transfer OD | B | B |
| | resistance | | | |

TABLE 8

| | | | Comp. Ex. | | | | | |
|---|---|---|---|---|---|---|---|---|
| | | | 1 | 2 | 3 | 4 | 5 | 6 |
| Pigment- | Preparation example | | — | — | 1 | 5 | 5 | — |
| encapsulating | Kind of resin | | — | — | Polyester | Polyester | Polyester | — |
| resin particles | | | | | resin α | resin α | resin α | |
| | Mass ratio | | — | — | 0.50 | 0.35 | 0.35 | — |
| | Pigment/Resin (P/R) | | | | | | | |
| | Pigment exposure ratio | | — | — | 0 | 0 | 0 | — |
| | (%) in pigment- | | | | | | | |
| | encapsulating resin | | | | | | | |
| | particles | | | | | | | |
| | Aspect ratio of pigment- | | — | — | 1.09 | 1.03 | 1.03 | — |
| | encapsulating resin | | | | | | | |
| | particles | | | | | | | |
| | Sphericity of pigment- | | — | — | 0.88 | 0.92 | 0.92 | — |
| | encapsulating resin | | | | | | | |
| | particles | | | | | | | |
| Resin | Name of resin particles | | e | a | f | — | a | e |
| particles | Kind of resin | | Polyester | Polyester- | Polyester | — | Polyester | Polyester |
| | | | resin α | based | resin β | | resin α | resin α |
| | | | | urethane | | | | |
| | | | | resin | | | | |
| | Tg (degree C.) | | 45 | −34 | 57 | — | −34 | −34 |
| | Young's modulus (MPa) | | 1,500 | 500 | 3,000 | — | 500 | 500 |
| Pigment alone | | | G | G | — | — | — | Resin- |
| | | | | | | | | coated |
| | | | | | | | | pigment |
| | | | | | | | | A |
| Ink | Ink No. | | 15 | 16 | 17 | 18 | 19 | 20 |
| prescription | Mass ratio | | 0.35 | 0.35 | 0.35 | 0.35 | 0.20 | 0.35 |
| | Pigment/Resin (P/R) in | | | | | | | |
| | ink | | | | | | | |
| | Resin particles/Total | | 0.74 | 0.74 | 0.22 | 0 | 0.36 | 0.22 |
| | solid content | | | | | | | |
| | Resin particles/Pigment- | | — | — | 0.29 | 0 | 0.56 | — |
| | encapsulating resin | | | | | | | |
| | particles | | | | | | | |
| Evaluation | Abundance ratio of | | D | D | B | C | C | D |
| results | pigment-encapsulating | | | | | | | |
| | resin particles in ink | | | | | | | |
| | Pigment exposure ratio | | D | D | B | B | B | D |
| | (%) in coating film | | | | | | | |
| | Image | OD (25 | B | B | B | B | D | B |
| | density | degrees C.) | | | | | | |
| | | OD (100 | D | D | B | B | D | D |
| | | degrees C.) | | | | | | |
| | | Surface | 59 | 83 | 8.2 | 1.1 | 6.4 | 92 |
| | | roughness | | | | | | |
| | | (nm) | | | | | | |
| | Scratch | Transfer | D | D | D | D | B | D |
| | resistance | OD | | | | | | |

Aspects of the present disclosure are, for example, as follows.

<1> An ink including:

pigment-encapsulating resin particles encapsulating a pigment; and

resin particles containing a resin different from a resin of the pigment-encapsulating resin particles.

<2> The ink according to <1>, further including

water or an organic solvent, or both.

<3> The ink according to <1> or <2>,

wherein the resin of the pigment-encapsulating resin particles contains a polyester resin.

<4> The ink according to <3>,

wherein the polyester resin contains a carboxyl group.

<5> The ink according to any one of <1> to <4>,

wherein the resin of the resin particles contains a urethane resin.

<6> The ink according to <5>,

wherein the urethane resin contains a carboxyl group.

<7> The ink according to any one of <1> to <6>,

wherein the resin particles have a glass transition temperature of −40 degrees C. or higher but 20 degrees C. or lower.

<8> The ink according to any one of <1> to <7>,

wherein a coating film of the ink has a Young's modulus of 100 MPa or higher but 1,000 MPa or lower.

<9> The ink according to any one of <1> to <8>,

wherein a mass ratio of the pigment to the resin the resin in the pigment-encapsulating resin particles is 0.25 or greater but 1.0 or less.

<10> The ink according to any one of <1> to <9>,

wherein a mass ratio of the resin particles to the pigment-encapsulating resin particles is 0.1 or greater but 0.5 or less.

<11> The ink according to any one of <1> to <10>,

wherein a measured value of a volume average particle diameter Ds of the ink is 30 nm or greater but 300 nm or less, and

an aspect ratio of the pigment-encapsulating resin particles is 1.0 or greater but 1.7 or less.

<12> The ink according to any one of <1> to <11>,

wherein the pigment contains an inorganic pigment.

<13> The ink according to <12>,

wherein the inorganic pigment is carbon black.

<14> The ink according to any one of <1> to <13>,

wherein the pigment-encapsulating resin particles encapsulate two or more primary particles of the pigment.

<15> The ink according to any one of <1> to <14>,

wherein a pigment exposure ratio in a surface of a coating film formed of the ink and having an average thickness of 2 micrometers is 8% or lower.

<16> A water-based dispersion including:

water;

pigment-encapsulating resin particles encapsulating a pigment; and

resin particles containing a resin different from a resin of the pigment-encapsulating resin particles.

<17> A printed matter including

a coating film,

wherein the coating film includes:
pigment-encapsulating resin particles encapsulating a pigment; and
a resin different from a resin of the pigment-encapsulating resin particles.

The ink according to any one of <1> to <15>, the water-based dispersion according to <16>, and the printed matter according to <17> can solve the various problems in the related art and achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An ink comprising:
pigment-encapsulating resin particles encapsulating a pigment; and
resin particles containing a resin different from a resin of the pigment-encapsulating resin particles.

2. The ink according to claim 1, further comprising
water or an organic solvent, or both.

3. The ink according to claim 1,
wherein the resin of the pigment-encapsulating resin particles comprises a polyester resin.

4. The ink according to claim 3,
wherein the polyester resin comprises a carboxyl group.

5. The ink according to claim 1,
wherein the resin of the resin particles comprises a urethane resin.

6. The ink according to claim 5,
wherein the urethane resin comprises a carboxyl group.

7. The ink according to claim 1,
wherein the resin particles have a glass transition temperature of −40 degrees C. or higher but 20 degrees C. or lower.

8. The ink according to claim 1,
wherein a coating film of the ink has a Young's modulus of 100 MPa or higher but 1,000 MPa or lower.

9. The ink according to claim 1,
wherein a mass ratio of the pigment to the resin in the pigment-encapsulating resin particles is 0.25 or greater but 1.0 or less.

10. The ink according to claim 1,
wherein a mass ratio of the resin particles to the pigment-encapsulating resin particles is 0.1 or greater but 0.5 or less.

11. The ink according to claim 1,
wherein a measured value of a volume average particle diameter D₅₀ of the ink is 30 nm or greater but 300 nm or less, and
an aspect ratio of the pigment-encapsulating resin particles is 1.0 or greater but 1.7 or less.

12. The ink according to claim 1,
wherein the pigment comprises an inorganic pigment.

13. The ink according to claim 12,
wherein the inorganic pigment comprises carbon black.

14. The ink according to claim 1,
wherein the pigment-encapsulating resin particles encapsulate two or more primary particles of the pigment.

15. The ink according to claim 1,
wherein a pigment exposure ratio in a surface of a coating film formed of the ink and having an average thickness of 2 micrometers is 8% or lower.

16. A water-based dispersion comprising:
water;
pigment-encapsulating resin particles encapsulating a pigment; and
resin particles containing a resin different from a resin of the pigment-encapsulating resin particles.

17. A printed matter comprising
a coating film,
wherein the coating film comprises:
pigment-encapsulating resin particles encapsulating a pigment; and
a resin different from a resin of the pigment-encapsulating resin particles.
